(19) United States
(12) Patent Application Publication
(10) Pub. No.: US 2026/0104989 A1
(43) Pub. Date: Apr. 16, 2026

(54) SOFTWARE APPLICATION TESTING USING ARTIFICIAL INTELLIGENCE

(71) Applicant: Google LLC, Mountain View, CA (US)

(72) Inventors: Adarsh Fernando, Kirkland, WA (US); Adhithya Ramakumar, Sunnyvale, CA (US); Grant Chieh-Hsiang Yang, Mountain View, CA (US); Stanislav Negara, Mountain View, CA (US); Subham Mishra, Bengaluru (IN); Raymond Leo Buse, Sunnyvale, CA (US); Zhinan Zhou, Newcastle, WA (US); Daniel Herrera Cortez, Mill Creek, WA (US)

(21) Appl. No.: 19/353,030

(22) Filed: Oct. 8, 2025

Related U.S. Application Data
(60) Provisional application No. 63/706,593, filed on Oct. 11, 2024.

(51) Int. Cl. G06F 11/3668; G06F 8/35

(52) U.S. Cl. CPC G06F 11/3688; G06F 8/35

(57) ABSTRACT

A method of testing a software application includes providing, from a device to an artificial intelligence model, input data indicative of a particular user journey associated with the software application. The method also includes identifying, by the artificial intelligence model and based on the input data, one or more journey steps of the particular user journey. The method also includes generating, by the artificial intelligence model, a natural language prompt for each journey step of the one or more journey steps. The method also includes storing the particular user journey as a set of natural language prompts that includes each natural language prompt generated based on the one or more journey steps.

### RELATED APPLICATION

This application claims benefit of U.S. Provisional Application No. 63/706,593, filed Oct. 11, 2024, the entire contents incorporated herewith.

### BACKGROUND

Software application developers often face challenges in testing software applications due to the increasing complexity associated with software applications and supporting frameworks. Manual testing of software applications, while widely adopted, may not be scalable. In some scenarios, automated instrumented tests may be used to test software applications; however, automated instrumented tests may require a substantial investment in various frameworks and technologies, constant maintenance of test code, etc. Thus, software application developers often are required to make trade-offs, sacrificing testing coverage for certain device configurations or user demographics.

Limited tooling may further exacerbate the cost and burden of maintaining effective software application testing strategies, leading to slower development cycles and hindering the ability of software application developers to efficiently identify and resolve issues.

### SUMMARY

A user loads a software application in a user interface of a device and the device records actions (e.g., a user journey) occurring in the user interface as the user interacts with the software application. The actions are sent to an artificial intelligence model for interpretation, and the interpreted actions are encoded as prompts to send back to the user for review. In some examples, the prompts may be text prompts. Collectively, the actions during the user journey that are encoded as prompts correspond to an encoded test. The completed encoded test may be sent to a host machine which then runs the actions through a decoder. The actions may be decoded by an artificial intelligence model and then distributed to one or more virtual or physical devices. After the tests are run at the one or more virtual or physical devices, the results may be returned to a user for display and further action. The artificial intelligence model could be a neural network, such as a large language model. In some examples, the artificial intelligence model doing the encoding may be a different model than the artificial intelligence model doing the decoding. In other examples, the artificial intelligence model doing the encoding may be the same model as the artificial intelligence model doing the decoding.

In a first example, a method of testing a software application includes providing, from a device to at least one artificial intelligence model, input data indicative of a particular user journey associated with the software application. The method also includes identifying, by the at least one artificial intelligence model and based on the input data, one or more journey steps of the particular user journey. The method also includes generating, by the at least one artificial intelligence model, a natural language prompt for each journey step of the one or more journey steps. The method also includes storing the particular user journey as a set of natural language prompts that includes each natural language prompt generated based on the one or more journey steps.

In a second example, a system includes a memory and a processor coupled to the memory. The processor is configured to provide, from a device to at least one artificial intelligence model, input data indicative of a particular user journey associated with a software application. The processor is also configured to identify, by the at least one artificial intelligence model and based on the input data, one or more journey steps of the particular user journey. The processor is also configured to generate, by the at least one artificial intelligence model, a natural language prompt for each journey step of the one or more journey steps. The processor is also configured to store the particular user journey as a set of natural language prompts that includes each natural language prompt generated based on the one or more journey steps.

In a third example, a non-transitory computer-readable medium includes instructions that, when executed by a processor, cause the processor to perform operations. The operations include providing, from a device to at least one artificial intelligence model, input data indicative of a particular user journey associated with a software application. The operations also include identifying, by the at least one artificial intelligence model and based on the input data, one or more journey steps of the particular user journey. The operations also include generating, by the at least one artificial intelligence model, a natural language prompt for each journey step of the one or more journey steps. The operations also include storing the particular user journey as a set of natural language prompts that includes each natural language prompt generated based on the one or more journey steps.

In a fourth example, a computer program product includes computer-executable program code. The computer-executable program code, when executed by a computer, causes the computer to provide, from a device to at least one artificial intelligence model, input data indicative of a particular user journey associated with a software application. The computer-executable program code, when executed by the computer, causes the computer to identify, by the at least one artificial intelligence model and based on the input data, one or more journey steps of the particular user journey. The computer-executable program code, when executed by the computer, causes the computer to generate, by the at least one artificial intelligence model, a natural language prompt for each journey step of the one or more journey steps. The computer-executable program code, when executed by the computer, causes the computer to store the particular user journey as a set of natural language prompts that includes each natural language prompt generated based on the one or more journey steps.

In a fifth example, a system may include various means for carrying out each of the operations of the first example.

In a sixth example, a method of testing a software application includes providing, from a device to at least one artificial intelligence model, a set of natural language prompts. Each natural language prompt in the set of natural language prompts corresponds to an encoded journey step of one or more journey steps of a particular user journey associated with the software application. The method includes decoding, by the at least one artificial intelligence model, the set of natural language prompts to generate a corresponding set of executable instructions indicative of the one or more journey steps of the particular user journey. The method includes providing the set of executable instructions to one or more second devices having the software application. The one or more second devices perform the particular user journey on the software application by executing the set of executable instructions. The method includes receiving, from each device of the one or more second devices, validation data indicating whether errors occurred when performing the particular user journey.

In a seventh example, a system includes a memory and a processor coupled to the memory. The processor is configured to provide, from a device to at least one artificial intelligence model, a set of natural language prompts. Each natural language prompt in the set of natural language prompts corresponds to an encoded journey step of one or more journey steps of a particular user journey associated with a software application. The processor is configured to decode, by the at least one artificial intelligence model, the set of natural language prompts to generate a corresponding set of executable instructions indicative of the one or more journey steps of the particular user journey. The processor is configured to provide the set of executable instructions to one or more second devices having the software application. The one or more second devices perform the particular user journey on the software application by executing the set of executable instructions. The processor is configured to receive, from each device of the one or more second devices, validation data indicating whether errors occurred when performing the particular user journey.

In an eighth example, a non-transitory computer-readable medium includes instructions that, when executed by a processor, cause the processor to perform operations. The operations include providing, from a device to at least one artificial intelligence model, a set of natural language prompts. Each natural language prompt in the set of natural language prompts corresponds to an encoded journey step of one or more journey steps of a particular user journey associated with a software application. The operations include decoding, by the at least one artificial intelligence model, the set of natural language prompts to generate a corresponding set of executable instructions indicative of the one or more journey steps of the particular user journey. The operations include providing the set of executable instructions to one or more second devices having the software application. The one or more second devices perform the particular user journey on the software application by executing the set of executable instructions. The operations include receiving, from each device of the one or more second devices, validation data indicating whether errors occurred when performing the particular user journey.

In a ninth example, a computer program product includes computer-executable program code. The computer-executable program code, when executed by a computer, causes the computer to provide, from a device to at least one artificial intelligence model, a set of natural language prompts. Each natural language prompt in the set of natural language prompts corresponds to an encoded journey step of one or more journey steps of a particular user journey associated with a software application. The computer-executable program code, when executed by the computer, causes the computer to decode, by the at least one artificial intelligence model, the set of natural language prompts to generate a corresponding set of executable instructions indicative of the one or more journey steps of the particular user journey. The computer-executable program code, when executed by the computer, causes the computer to provide the set of executable instructions to one or more second devices having the software application. The one or more second devices perform the particular user journey on the software application by executing the set of executable instructions. The computer-executable program code, when executed by the computer, causes the computer to receive, from each device of the one or more second devices, validation data indicating whether errors occurred when performing the particular user journey.

In a tenth example, a system may include various means for carrying out each of the operations of the sixth example.

In an eleventh example, a method of testing a software application includes providing, from a device to at least one artificial intelligence model, input data indicative of a particular user journey associated with the software application. The method also includes identifying, by the at least one artificial intelligence model and based on the input data, one or more journey steps of the particular user journey. The method also includes generating, by the at least one artificial intelligence model, a natural language prompt for each journey step of the one or more journey steps. The method also includes storing the particular user journey as a set of natural language prompts that includes each natural language prompt generated based on the one or more journey steps. The method also includes providing, from the device to the at least one artificial intelligence model, the set of natural language prompts. The method also includes decoding, by the at least one artificial intelligence model, the set of natural language prompts to generate a corresponding set of executable instructions indicative of the one or more journey steps of the particular user journey. The method also includes providing the set of executable instructions to one or more second devices having the software application. The one or more second devices perform the particular user journey on the software application by executing the set of executable instructions. The method also includes receiving, from each device of the one or more second devices, validation data indicating whether errors occurred when performing the particular user journey.

In a twelfth example, a system includes a memory and a processor coupled to the memory. The processor is configured to provide, from a device to at least one artificial intelligence model, input data indicative of a particular user journey associated with a software application. The processor is configured to identify, by the at least one artificial intelligence model and based on the input data, one or more journey steps of the particular user journey. The processor is configured to generate, by the at least one artificial intelligence model, a natural language prompt for each journey step of the one or more journey steps. The processor is configured to store the particular user journey as a set of natural language prompts that includes each natural language prompt generated based on the one or more journey steps. The processor is configured to provide, from the device to the at least one artificial intelligence model, the set of natural language prompts. The processor is configured to decode, by the at least one artificial intelligence model, the set of natural language prompts to generate a corresponding set of executable instructions indicative of the one or more journey steps of the particular user journey. The processor is configured to provide the set of executable instructions to one or more second devices having the software application. The one or more second devices perform the particular user journey on the software application by executing the set of executable instructions. The processor is configured to receive, from each device of the one or more second devices, validation data indicating whether errors occurred when performing the particular user journey.

In a thirteenth example, a non-transitory computer-readable medium includes instructions that, when executed by a processor, cause the processor to perform operations. The operations include providing, from a device to at least one artificial intelligence model, input data indicative of a particular user journey associated with a software application. The operations include identifying, by the at least one artificial intelligence model and based on the input data, one or more journey steps of the particular user journey. The operations include generating, by the at least one artificial intelligence model, a natural language prompt for each journey step of the one or more journey steps. The operations include storing the particular user journey as a set of natural language prompts that includes each natural language prompt generated based on the one or more journey steps. The operations include providing, from the device to the at least one artificial intelligence model, the set of natural language prompts. The operations include decoding, by the at least one artificial intelligence model, the set of natural language prompts to generate a corresponding set of executable instructions indicative of the one or more journey steps of the particular user journey. The operations include providing the set of executable instructions to one or more second devices having the software application. The one or more second devices perform the particular user journey on the software application by executing the set of executable instructions. The operations include receiving, from each device of the one or more second devices, validation data indicating whether errors occurred when performing the particular user journey.

In a fourteenth example, a computer program product includes computer-executable program code. The computer-executable program code, when executed by a computer, causes the computer to provide, from a device to at least one artificial intelligence model, input data indicative of a particular user journey associated with a software application. The computer-executable program code, when executed by the computer, causes the computer to identify, by the at least one artificial intelligence model and based on the input data, one or more journey steps of the particular user journey. The computer-executable program code, when executed by the computer, causes the computer to generate, by the at least one artificial intelligence model, a natural language prompt for each journey step of the one or more journey steps. The computer-executable program code, when executed by the computer, causes the computer to store the particular user journey as a set of natural language prompts that includes each natural language prompt generated based on the one or more journey steps. The computer-executable program code, when executed by the computer, causes the computer to provide, from the device to the at least one artificial intelligence model, the set of natural language prompts. The computer-executable program code, when executed by the computer, causes the computer to decode, by the at least one artificial intelligence model, the set of natural language prompts to generate a corresponding set of executable instructions indicative of the one or more journey steps of the particular user journey. The computer-executable program code, when executed by the computer, causes the computer to provide the set of executable instructions to one or more second devices having the software application. The one or more second devices perform the particular user journey on the software application by executing the set of executable instructions. The computer-executable program code, when executed by the computer, causes the computer to receive, from each device of the one or more second devices, validation data indicating whether errors occurred when performing the particular user journey.

In a fifteenth example, a system may include various means for carrying out each of the operations of the ninth example.

These, as well as other examples, aspects, advantages, and alternatives, will become apparent to those of ordinary skill in the art by reading the following detailed description, with reference where appropriate to the accompanying drawings. Further, this summary and other descriptions and figures provided herein are intended to illustrate examples by way of example only and, as such, that numerous variations are possible. For instance, structural elements and process steps can be rearranged, combined, distributed, eliminated, or otherwise changed, while remaining within the scope of the examples as claimed.

### BRIEF DESCRIPTION OF THE DRAWINGS

FIG. 1 illustrates a computing system operable to test software applications using artificial intelligence, in accordance with examples described herein.

FIG. 2 illustrates an example of a computing process for testing software applications using artificial intelligence, in accordance with examples described herein.

FIG. 3 illustrates an example of a computing process for encoding a user journey as a set of prompts using artificial intelligence, in accordance with examples described herein.

FIG. 4 illustrates another example of a computing process for testing software applications using artificial intelligence, in accordance with examples described herein.

FIG. 5 illustrates another example of a computing process for testing software applications using artificial intelligence, in accordance with examples described herein.

FIG. 6 illustrates another example of a computing process for testing software applications using artificial intelligence, in accordance with examples described herein.

FIG. 7 illustrates another example of a computing process for testing software applications using artificial intelligence, in accordance with examples described herein.

FIG. 8 illustrates another example of a computing process for testing software applications using artificial intelligence, in accordance with examples described herein.

FIG. 9 illustrates another computing system operable to test software applications using artificial intelligence, in accordance with examples described herein.

FIG. 10 illustrates a flow chart, in accordance with examples described herein.

FIG. 11 illustrates another flow chart, in accordance with examples described herein.

FIG. 12 illustrates another flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any example or feature described herein as being an “example,” “exemplary,” and/or “illustrative” is not necessarily to be construed as preferred or advantageous over other examples or features unless stated as such. Thus, other examples can be utilized and other changes can be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall examples, with the understanding that not all illustrated features are necessary for each example.

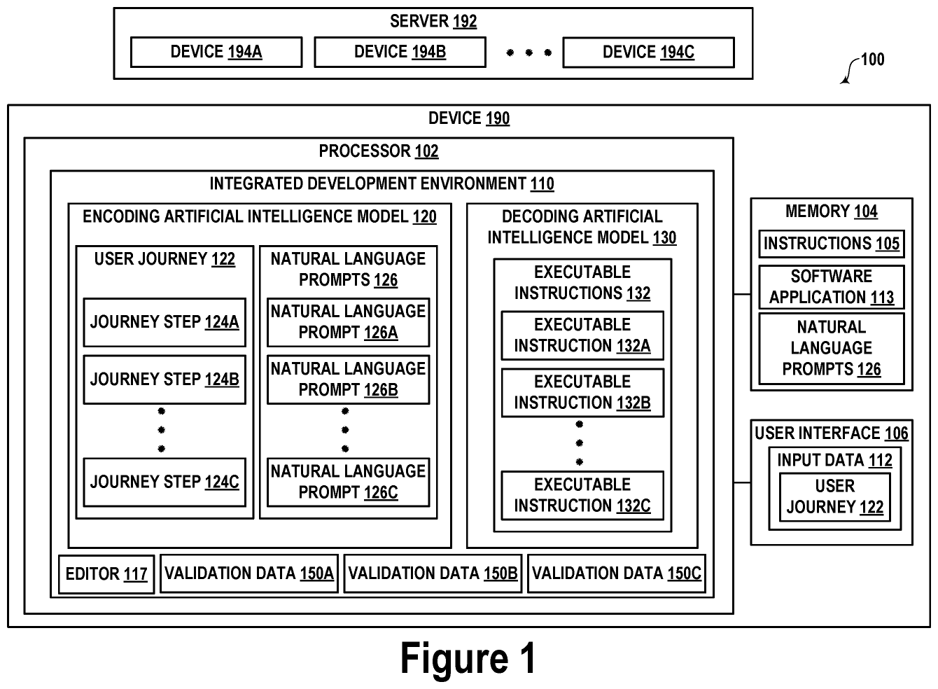

Particular examples are described herein with reference to the drawings. In the description, common features are designated by common reference numbers throughout the drawings. In some figures, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple journey steps are illustrated and associated with reference numbers 124A, 124B, and 124C. When referring to a particular one of these journey steps, such as the journey step 124A, the distinguishing letter “A” is used. However, when referring to any arbitrary one of these journey steps or to these journey steps as a group, the reference number 124 is used without a distinguishing letter.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

The techniques described herein improve software application testing by leveraging artificial intelligence (e.g., an artificial intelligence model) to record and automate testing steps for application software at scale with human-like intuition. In particular, artificial intelligence may be used to understand user intent, user interactions, and user journeys to automate the testing steps for the software application. As a result, the scalability of testing of the software application may be improved, resource constraints associated with testing the software application may be alleviated, and tooling limitations associated with testing the software application may be alleviated.

With regards to scalability, traditionally, testing software applications may present certain challenges for software application developers. To illustrate, a software application may be targeted to operate on different product surfaces (e.g., web browsers), device models, form factors (e.g., watch, phone, tablet, etc.), operating systems, and locales. The wide variety of platforms to which the software application is targeted may necessitate extensive testing. Manual testing may not be scalable and automated testing may require a substantial investment in writing and maintaining test scripts. Additionally, many testing frameworks, often specific to technologies or platforms being tested, may require investment in training to leverage and implement. In some scenarios, multiple frameworks may be employed for an end to end test to be effectively written.

With regards to resource constraints, traditionally, many software application development teams may lack the resources to maintain sufficient quality assurance. In particular, a quality assurance team may be necessary to handle the complexity and scale for comprehensive testing of software applications across different platforms. Software application development teams often rely on individual software application developers to fulfill quality assurance tasks, which in turn, diverts the focus of the individual software application developers from core development tasks.

With regards to tooling limitations, traditionally, existing tools and solutions to detect and identify performance and functional issues (in the software application) often fail to alleviate toil and complexity that software application developers experience when trying to improve the quality of the software application. These tooling limitations may lead to inefficiencies in identifying, investigating, and debugging functional quality issues.

Thus, the resource constraints and tooling limitations described above may cause software application developers to prioritize testing software applications on certain device configurations, features, or user demographics over others. This may result in undiscovered issues affecting specific user segments. Furthermore, the time and resources spent on manual testing and debugging represent significant opportunity costs for software application development teams, which in turn, may hamper the ability to quickly innovate and deliver new features.

The techniques described herein resolve the above-identified challenges associated with software application testing by leveraging generative artificial intelligence to enable software application developers to test critical user journeys of the software applications across a wide range of devices to efficiently identify potential issues. By providing an end-to-end solution within an integrated development environment, the techniques described herein may streamline the testing process, reduce manual testing, and improve the overall quality of software applications.

An artificial intelligence model may be configured to generate a catalog of critical user journeys for a particular software application. For example, having observed a large number of production analytics from the particular software application and/or other software applications, the artificial intelligence model may develop an understanding of common critical user journeys and issues with the particular software application. The catalog of critical user journeys may be the basis for software application testing. For example, software application developers may select, from the catalog, critical user journeys relevant to the particular software application. In response to selecting the critical user journeys, test scripts that simulate the selected critical user journeys may be automatically generated across a wide range of devices and configurations.

The generated test scripts may be executed using a remote server (e.g., in the “cloud”) using real or virtual devices. As a result, software application developers may bypass maintenance and use of local devices to ensure comprehensive testing coverage of the particular software application across various product surfaces, device models, form factors, operating systems, locales, etc. In some scenarios, the software application testing can be integrated into developer tools (e.g., integrated development environments). Thus, software application developers can initiate tests, monitor progress, and view results directly from the developer tools, which enables a streamlining of workflow and reduces context switching.

Using the developer tools, detailed feedback on the test results (e.g., crashes, application not responding incidents, user interface layout issues, performance bottleneck issues, etc.) may be provided to the software application developers. Thus, the artificial intelligence model's understanding of user intent may be leveraged to identify potential issues that may not be immediately apparent from test results alone.

The above-described framework alleviates the scalability challenges associated with traditional software application testing. For example, by automating test generation and execution at the remote server, the above-described framework reduces or eliminates the need for manual testing or extensive investment in automated test scripts. As a result, software application developers may test software applications across a wide range of devices and configurations without requiring additional resources. Additionally, the catalog of critical user journeys generated by the artificial intelligence model may improve (e.g., reduce) the time needed to define and create test cases. For example, because the above-described framework leverages artificial intelligence models at the remote server to generate test scripts, comprehensive tests, from core journeys to testing edge cases, may be defined without human intervention.

Additionally, the above-described framework alleviates the tooling limitations associated with traditional software application testing. For example, by integrating the artificial intelligence model with the integrated development environment, software application developers may be provided with a comprehensive testing solution within a familiar environment. The detailed feedback may assist software application developers in identifying and resolving any problems. Additionally, by leveraging the artificial intelligence model's understanding of critical user journeys, the above-described framework can generate tests that cover a wide range of user interactions and scenarios, which may ensure that the particular software application functions correctly across diverse user journeys and device configurations.

There are many types of testing that occur during the lifecycle of software, either manual, automated, or a hybrid approach. The testing can also be for different purposes that can help reduce developer toil.

A development and release software development life cycle may include a code phase, a build phase, a test phase, and a release phase. During each of the phases, testing typically occurs, either manually or in an automated way. There are different scenarios where manual testing would be advantageous. Manual testing may be less scalable, but when new code is generated and behavior in the application is less predictable, a developer may want to rely on manual testing, even though it may be more tedious. On the other hand, a developer may typically write automated tests, such as a unit test, as they are developing, as these tests are the smallest functional unit of code and are more predictable as to their behavior. Integration tests, which test multiple modules and typically combined modules or behavior, are more likely where a developer will lean on manual testing. In addition, a developer may play around with different behavior. For example, the developer may want to see (i) how an application reacts when a button is in different locations or (ii) the responsiveness of an application based on which assets or libraries are loaded.

The coding phase in the development and release software development life cycle may be a stage where the design and requirements of a software system are transformed into tangible code. The coding phase serves as the foundation upon which the entire software system is built, and the success of the software system hinges on the quality of the code produced.

During the coding phase, developers typically use their programming skills and expertise to translate the abstract design concepts into a series of precise instructions that the computer can understand and execute. With the emergence of large language models (LLMs), artificial intelligence can assist developers to author code based on various sources of information, including requirement documents, user journey descriptions, user interface mockups, and code comments.

LLMs may be trained on vast amounts of text data, including code snippets, documentation, and natural language descriptions. This training enables LLMs to understand the semantics of code and generate code that is both syntactically correct and semantically meaningful. LLMs can be used to generate code skeletons or even complete code snippets based on a given prompt. LLMs can suggest code completions as developers are typing, helping developers to write code faster and with fewer errors. LLMs can be used to refactor code, making it more efficient, readable, and maintainable.

The build phase, especially in larger complex applications, involves transforming the code into executable binaries which involve building, testing, and releasing to production in continuous delivery. Since many developers may be merging source code, developer changes may be automatically tested before being merged. The build system may typically be optimized for both speed and correctness, and the build system may handle testing and building of the internal and external dependencies in the source code.

During the build process, any number of codeless test scenarios may be run during pre-submit or post-submit. However, testing, especially on actual physical mobile devices, may be prone to inconsistent results (a characteristic referred to as “flakiness”). In other words, due to the nature of the instability of running tests on physical devices, there may be tests that fail but are actually false positives. In such cases, the codeless test scenarios may also use an artificial intelligence model to detect such failures and optimize to run these tests in post-submit, to automatically re-run, or to skip when needed.

In example testing suites described herein, there is typically context from pre-existing usage about any issues that are being fixed. For example, crashes typically generate a stack trace, analytics data may also provide information about what users were doing in the application, and during reproduction, developers may attempt to identify the exact application state or issue causing the crash. In some instances, a crash in an application may be caused by any number of factors, such as the operating system, an application bug, the state of the application, or a server message. Any combination of information and the surrounding code affected may be used to help hone in on the cause of the issue and the exact changes to the code.

Examples described herein can cover two types of self-healing: (a) repairs to tests, and (b) repairs to the code of the application under test. Self-healing may be a process in which a service detects and repairs tests or the code that are failing at some frequency with the intent to make the tests pass, while achieving the original goals and desired outcomes of the tests and the application under test.

Self-healing is typically triggered when a test failure is encountered consistently, that is, when the steps and desired outcomes of a test cannot be completed. An additional trigger for detecting the need to self-heal a test is test flakiness. A flaky test may be one that generates inconsistent results, failing or passing unpredictably, without any changes to test code. For example, when testing a mobile application on a real physical device, there may be issues with the actual hardware that could be causing the flakiness, such as overheating, a swollen battery, or a problem with the operating system version. This may be true if using a beta build of an operating system. Either way, the system may need to detect changes to the application under test that render previous prompts in the test to become obsolete with the application in order to determine whether a change should be focused on the test or application under test. In some scenarios, there may be some analysis of the content and goals of encoded steps to determine the desired results of the test. In either case, there may be a need to make modifications to either the prompts in the test, or the code of the application under test, such that the goals and desired outcomes of the original test are met and the test passes consistently.

Upon completion of a test, an automated testing system may initiate a comprehensive evaluation process to determine the test's outcome. If the test is successful, the test result will be presented in the user interface, indicating that all test parameters were met and the desired results were achieved. This positive outcome signifies that the tested feature or functionality is operating as intended and meets the specified requirements.

Conversely, if the test fails, the system may gather and securely store all relevant failure artifacts. These artifacts may include error messages, stack traces, screenshots, the implementation source code, the test journey file, and any other pertinent information that can shed light on the root cause of the failure. By collecting and preserving these artifacts, the system ensures that they are available for further analysis by developers, traditional software systems, or artificial intelligence systems.

To enhance the comprehension capabilities of an artificial intelligence system, a service can leverage collected failure artifacts to construct prompts in a format that aligns with the artificial intelligence system's requirements and specifications. The prompts may be designed to guide the artificial intelligence system towards understanding the context and nature of the failures, as well as the specific actions or behaviors that led to the failures. To ensure the effectiveness of the prompts, the service may employ iterative refinement techniques. The refinement techniques may involve soliciting feedback from human experts, conducting controlled experiments, or utilizing automated optimization algorithms. The goal is to fine-tune the prompts to maximize the prompts'relevance and clarity for the artificial intelligence system.

Once the prompts have been crafted and finalized, the prompts are then delivered to the artificial intelligence system through a designated interface or a reliable communication channel. The integration of these prompts into the artificial intelligence system's inference processes enables the artificial intelligence system to perform specific tasks or generate desired outputs based on the information provided in the prompts.

The artificial intelligence system analyzes the content of the prompts, which serve as inputs, to extract relevant information. This information may then be processed and utilized by the artificial intelligence system to inform its reasoning and decision-making processes. Through this analysis, the artificial intelligence system may be able to identify potential issues or areas for improvement. As a result of this inference process, the artificial intelligence system generates a failure explanation, which provides insights into the cause of any identified problems. Additionally, the artificial intelligence system suggests fixes to address these issues. These fixes can come in various forms, such as code diffs that propose modifications to the implementation code or modified test cases that help to validate the system's behavior.

Before being sent for change review by developers or other software systems, the fix suggestions may undergo a validation process to ensure quality and feasibility. The validation process may encompass multiple criteria essential for successful code integration and execution. For example, the validation process may include code style validation, compile validation, execute validation, etc. By undergoing this comprehensive validation process, the fix suggestions may be refined and polished before being presented for change review. This approach enhances the quality of code changes, reduces the likelihood of introducing new issues, and facilitates smoother integration.

When the service recommends a change to either the test or the application code, the changes can be reviewed and committed by (i) a user manual review and acceptance or (ii) automatic code changes. In both of the scenarios above, confidence in the recommended changes may be increased with automatic validation of the code changes. During validation, code changes are applied in a different branch, or copy, of the application code, and the test may be run to determine whether the test passes or fails. If the test passes, the suggested code changes are either published for review or applied automatically, depending on the configuration of the service. If the validation fails, the service may attempt the process to self-heal any number of additional times, with the context of previous attempts included. Once new changes are validated, these modified encoded prompts are updated as a new version of the encoded journey.

Self-healing may inform the developer of issues that they may not be able to fix. For example, if the issue is determined to be an operating system issue versus an application issue, the issue may be deprioritized and a message may automatically be sent to the operating system support. Alternatively, if the issue is an operating system issue specific to an original equipment manufacturer, then the issue may be flagged during prioritization.

As a developer makes incremental changes, it is highly likely that the developer may be frequently building and testing specific parts of their application. Having a codeless test that could replace the manual nature of the testing may save a significant amount of time. In addition, a codeless test may be performed in conjunction with a manual test. For example, there may be a situation where a user is testing a new first time user experience flow by sharing a newly created document in a document creation application. In order to test the sharing functionality, the developer might have to install the application, sign in as a new user, go through all the tutorial flows, create a new document, potentially write some random text, and only then could the developer actually get to the sharing functionality they want to test. A codeless test scenario could be created that performs each step in the above-mentioned sequence and returns a signal that the entire sequence was validated. Alternatively, a developer may want to perform the sharing to validate the behavior. The developer could insert the equivalent of a breakpoint at the sharing step, where the codeless test scenario execution would perform all the way up until the share occurs. Then a developer could take over and perform the last step. In other instances a quality assurance engineer may want to insert behavior to try and break the flow. The quality assurance engineer may be able to request the codeless test scenario to perform random actions to try and cause a crash or put the application in a state that breaks the ultimate sharing behavior. Alternatively, the quality assurance engineer could have the codeless test scenario execution perform all the main steps and then randomly crawl after sharing was validated.

In examples described herein, a method for executing a user journey by inputting the user journey in a textual or visual manner is described. The user journey can be adaptively replayed or executed without having to write instrumentation test code.

The user journey may broadly be a user interaction or a set of user interactions that a user may take in the particular software application or with a device. In some scenarios, the user journey may incorporate all the steps that the instrumentation test code may take. As a non-limiting example, the particular user journey may be described at a high level, such as text stating “a user writes and sends an email”. As another non-limiting example, the user journey may be described as a single action, such as a test stating “a user clicks the send button”. As yet another non-limiting example, the user journey may be described as a detailed sequence of a specific flow, such as text stating “a user opens the mobile application, clicks the compose button from the main screen, attaches a file, adds random characters in the subject and body, adds ‘address1@email.com’ to the ‘to’ field and ‘address2@email.com’ to the ‘cc:’ text field, and clicks the send button.” In addition, the intermediate actions expected to occur may also be in that user journey flow. For example, in the “attach a file” step, it may be implied that commands are sent to retrieve a file list and, if no file is specified, then any file can be attached.

It may be difficult to observe actions and interpret an “intent”. For example, a user may have a test scenario where a series of actions may include opening the video sharing application, scrolling through a feed of videos, scrolling past 20 feed items, and scrolling back to click on the 7th video entitled “Best Break-dancers in Australia” that has 30 million views. There are a lot of steps to breakdown in the video that could be open for interpretation. For instance, the scrolling may be interpreted as simply scrolling, scrolling enough to get another application programming interface requests worth of feed items, scrolling enough to get at least 10 items, or scrolling until specific videos are in the feed. In addition, the goal of the test may be for a user to click on the seventh video in the feed, the user to click on the “Break-dancing in Australia” video (which could appear anywhere in the feed in other test passes), or the user to click on the first video that is over 20 million views. The broadness in the level of interpretability makes it difficult to create the reliability expected of scripted tests versus having the flexibility of a test performed by a manual reviewer. One advantage of the techniques described herein is there are two processes that occur in the creation and execution of the codeless test scenario, an encoding step and a decoding step. The advantages that this two-process method has over other methods of creating tests using artificial intelligence models is that it allows for easier debugging and it allows for the ability to balance intent with repeatability.

With respect to an ability to debug, if an artificial intelligence model were to go directly from an input test scenario to the execution of that test via an artificial intelligence model, the artificial intelligence model may be prone to errors. In addition, unless an application is only using a static model that is never re-trained, an input to an artificial intelligence model may inherently have a variance in output. In addition, some artificial intelligence models, such as large language models, are purposefully non-deterministic, meaning that if you feed in the exact same prompt, you may get two different results. When factoring in the variation in the user interface, there may be a large variance between an input prompt and the actual behavior resulting from the artificial intelligence model versus the expected validation. For example, for in-application purchases, some applications employ split testing (e.g., “A/B testing”) where two or more versions of the application are compared to determine which version performs better. Or, there may be multiple ways to purchase items and both paths should be tested. A quality assurance engineer may not be able to easily create a single prompt to differentiate the divergent paths. The artificial intelligence model may keep going down the same purchase flow, whereas by encoding first, a user has an ability to correct the artificial intelligence model at the point of divergence.

One aspect of manual testing is that a real human is flexible enough to observe the intent of a test. Therefore, the more flexible an artificial intelligence model is to interpretation, the more variance it will accept in the actual execution. As the application itself changes, one factor for a quality assurance team determining release is whether all tests have passed. Therefore, even if an artificial intelligence model is non-deterministic, all the things that need to be validated still have to occur, or the artificial intelligence model needs to know that this is not possible (or that it is possible but not from the original path designated when a test is first created). For example, if a button is renamed or moved to a completely different page, an automated test may break because the automated test is strictly testing exact button clicks to get to an end result of clicking the button. However, if a button is renamed, for example, from “Free” to “Get”, and the functionality is the same, the artificial intelligence model may be able to interpret that clicking the new button “Get” is the intent and that the functionality of “Get” should be the same as when the prompt said to click on “Free”.

The artificial intelligence models described herein offer essential capabilities, such as understanding user interfaces, sanitizing and validating prompts, and providing explanations and suggestions in case of failures. The artificial intelligence models acquire and provide these capabilities through training. Artificial intelligence model training involves teaching an artificial intelligence model to execute specific tasks or a set of tasks by exposing it to extensive data. The primary objective is to train the model to make accurate predictions and decisions autonomously, without requiring human intervention.

The user interface understanding capability is developed through screen annotation and question answering. Screen annotation involves identifying and labeling various elements on a screen, such as buttons, text boxes, and images using a layout annotator. Human trainers analyze extensive screenshots captured from mobile devices, which showcase a wide range of user interface elements. The identified elements are labeled with descriptive information such as their bounding box coordinates and any text displayed on them. This information is then utilized to create a schema of the screen, which serves as a training tool for the question answering task.

By leveraging an LLM, question answering tasks can be accomplished on a significant scale. The LLM undergoes training using a diverse range of datasets, encompassing screen annotation data and various image and textual sources. This comprehensive training enables the LLM to acquire the ability to answer questions related to the content displayed on screens. Furthermore, the LLM's proficiency in question answering extends beyond static screens. The LLM's proficiency may also handle dynamic screens, such as those found in interactive applications and videos. By leveraging its temporal reasoning capabilities, the LLM can track changes in the content displayed over time and answer questions, accordingly. Once the LLM has completed its training phase, it can be utilized to provide answers to questions about novel screens that it has not previously encountered.

In some examples, the particular software application may be tested by inputting, into the artificial intelligence model, a particular user journey in a visual or textual manner that can be adaptively replayed or executed without having to write instrumentation test code. Thus, the artificial intelligence model may be configured to receive input data indicative of the particular user journey.

To illustrate, the software application developer may utilize an integrated development environment (IDE) to provide application software to a device. The IDE may observe (i) visual changes on the device as the particular user journey is performed and (ii) interactions with an application user interface and the device during the particular user journey. The artificial intelligence model may (i) identify the user interactions with the software application or the device to perform each step (e.g., journey step) of the particular user journey and (ii) encode each user interaction as a prompt written in natural language. These prompts are stored as a formatted set of prompts as the particular user journey.

In this context, a prompt is a piece of text or a set of instructions that can be provided to an artificial intelligence model, such as a large language model, to trigger a specific action or check for a desired property. For example, “tap on the cat” communicates the intent of the user to execute a tap action on the image of a cat. Similarly “there is a cat” indicates that the screen should be checked for the image of a cat.

In some scenarios, the particular user journey may be encoded as a textual description in natural language of the particular user journey. The particular user journey may be specified as a series of steps (e.g., click “start”, type “cat”), any of which may decompose into multiple concrete actions. In some scenarios, the particular user journey may be encoded as a sequence of user actions performed on the device, either virtual or physical, and either remote or local.

The software application developer may load the software application into the IDE containing the particular user journey. Loading the particular user journey may include (i) loading a stream of the software application running on a device, (ii) loading a pre-recorded video recording that is uploaded or recorded by the IDE, or (iii) loading a set of screenshots depicting the software application running on a device and steps of the particular user journey being performed. The user interface may display the current state of the software application, beginning with the state just after launch, though there could be scenarios where different pre-saved states could also exist. The pre-saved states may be useful for where common states of a device have to exist but it would take a long time to set up the device before getting to the core steps of the particular user journey.

For visual changes made on the device being observed by the artificial intelligence model, the captured user interface may be analyzed by the artificial intelligence model to determine the nature, context, and intention of the user, and from that analysis elicit one or more prompts intended to recreate the interaction or outcome during a test. Visual changes in the user interface that are analyzed may include, the shape of elements, the color of elements, decorations applied to the elements, text in the user interface, the state of controls, animations of objects, changes to pixels or a collection of pixels on the screen intended to communicate information to the user, the existence of media on the screen, etc.

Additionally, the use of audio may be captured and analyzed, particularly if the use of audio is intended to communicate some information to the user. Some examples of audio information that may be analyzed include the existence of media played to the user, audio notifications, audio assets that are played in combination of visual events, etc.

Interactions with the software application or with the device may also be observed. When the action corresponds to specific objects in the software application's user interface hierarchy (e.g., a button, a text box, etc.), information about this target element may also be captured. This information (e.g., action type, action coordinates, hierarchy information, screenshot, etc.) may be passed to the artificial intelligence model, which is prompted to “Describe the specific action in text such that it can be easily understood and reliably reproduced.” The response may be given in a structured format relevant to the type of action. For example, text entry actions may specifically designate the input text. The result is that for each action, the artificial intelligence model produces a human-readable string that encodes the information about the action sufficient to reproduce it.

The interactions may be encoded as prompts. In the case that the testing scenario is specified via user actions, the actions may be encoded as text descriptions. When the encoded test descriptions are saved as a file, they are considered the artifacts of the particular user journey for a codeless test. These descriptions are generated to ensure they are robust without overfitting. In some examples, the artificial intelligence model can be directed so that when less details are provided, the artificial intelligence model will try to take the most likely or common action. For internal data, the artificial intelligence model can look at previous runs and also manual corrections that a software application developer has made specifically in journeys created by the artificial intelligence model for the software application. In addition, the artificial intelligence model may analyze anonymized and aggregated analytics regarding the behavior of users of the software application to determine a likely action that is meant to be tested, ensuring no individual user's data is processed. Alternatively, the artificial intelligence model could look externally at the genre of the software application and actions made in similar software applications to determine the best type of behavior. Or, the artificial intelligence model could look at a family of software applications made by the same software application developer.

During the encoding phases, there could be intermediate steps that allow a user to see the prompts generated. Some reasons to allow this phase are what differentiate a goal-oriented approach vs a directed approach. In a goal-based approach, the tester defines the goal of the test and it doesn't matter how the software application gets there. On the other hand, in a directed-based approach, the user is directed through specific actions via the particular user journey, which may include the eventual steps of the goal.

The encoding may be performed in real-time or at the end of the particular user journey. For example, encoding may be performed while a user is acting in real-time on a streamed device and repeated as screenshots and actions are coming into the artificial intelligence model. Alternatively, a user can record all his actions in a single video which gets sent to the artificial intelligence model to perform the encoding at once.

One key distinguishing advantage in the directed-approach is that software application developers may be provided the intermediate steps to debug. In other words, software application developers have a way of viewing and inspecting each prompt encoded in the particular user journey, editing the prompts encoded in the particular user journey as natural language instructions, saving the edits to the encoded journey, and logging the edits as additional context. If the encoded portion is incorrect, which provides the artificial intelligence model's interpretation of the original input, the actual executed test would also be incorrect. Edited prompts may also be fed back into the artificial intelligence model for the individual to see how the set of cumulative prompts could have been defined or summarized to be used in a goal-based approach.

In addition, there can be suggestions for prompt editing. For example, an initial prompt may be interpreted differently than the intention of the user. The user could potentially edit a prompt incorrectly (e.g., edit the prompt in a way that would be interpreted in decoding differently). For example, a person unfamiliar with the semantics may say “swipe a button” instead of “click a button”. Having an IDE may enable a dropdown that suggests “did you mean . . . ‘click a button’”. In addition, the IDE could use other users' previous inputs to provide the right behavior.

The final encoded prompt sequence may be stored as the particular user journey. When the prompts are encoded, the prompts are represented in a pre-defined structure so that the prompts can be stored for later retrieval, interpretation, and modification. The structure or file type may be used to extract specific fields to provide to the artificial intelligence model later in the decoding stage. In addition, the IDE may also represent the structure in a graphical user interface (GUI) so that it is easier to author, review, and edit the prompts.

When a software application developer edits a prompt, they can take any number of actions with the encoded script. In one scenario, the software application developer may modify the configuration of the test script. For example, the software application developer may change the number of times the test is run to check for test flakiness or add more contextual information to the test. In another scenario, the software application developer may modify a discrete prompt that is an action to change the type of interaction, the object being interacted with, or the way the action is described. In another scenario, the software application developer may modify a discrete prompt that is an assertion to change the context of the assertion, the stated goal or desired outcome that is being asserted, or the way the assertion is described. In another scenario, the software application developer may add to the encoded set of prompts to represent a new action or assertion, or divide an existing prompt into two or more granular prompts. The added prompts may be appended to position in the set of existing prompts that make the most logical sense for the purpose of the test. In other scenarios, the software application developer may delete an existing prompt.

The structure may be sufficiently expressive to not only capture the encoded prompts, but also represent higher level controls over how these prompts are interpreted. For example, controls may be included specifying the maximum number of times a given prompt can be evaluated and conditions on the application's state that trigger evaluation of a sequence of one or more prompts.

After user actions are encoded and intent is determined, the instructions for the particular user journey may be sent for execution to test, where the actions are decoded and provided as input to a testing mechanism. The testing mechanism may be an input into a crawler or potentially another artificial intelligence model that generates code usable to perform a test on the fly.

At a high level, the decoding of the testing system executes the testing scenario. Execution of the testing scenario may be achieved by having the text-based descriptions (either provided directly by users or by loading a journey with the one or more prompts encoded in natural language from above) combined with additional prompt text and passed to an artificial intelligence model, such as a multi-modal LLM, with a screenshot of the current application screen state. As a result, text-based descriptions and the additional prompt text may be decoded into one or more concrete actions which can be performed on the device. In addition, for the execution, the actual application may be loaded onto a device, such as a virtual or real physical device. The prompt instructions, either actions or assertions, may be performed on the application to satisfy the prompts. The prompts, written in natural language, may also be validated and the result of the validation would be returned, either to the user in a user interface or potentially to a system to be joined with other analytics.

The user or machine-generated assertion and action descriptions may be prepared as prompts for artificial intelligence model evaluation and then performed as assertions and actions on the device. A prompt may be prepared using a prefix and suffix text depending on whether the prompt is an action (meant to return the details of an action to be performed on the device like screen coordinates, direction of a swipe, etc.) or an assertion (meant to evaluate a condition).

If a prompt is an assertion, the artificial intelligence model evaluates the prompt with a response of only “yes” or “no”, which determines the outcome of the assertion. If an assertion fails, the process stops. Otherwise, the next prompt, if present, is prepared for evaluation. An assertion checks for presence or absence of different visual cues on the device screen like a radio button being selected, or the panel having a specific color, or that the screen does not have a warning text. Similarly, assertions can check for the overall application state on the device, like whether the application is still running, whether the application is non-responsive, or whether the application crashed.

If a prompt is an action (e.g., a user interaction), the artificial intelligence model may conclude that the corresponding prompt has completed. Then the next prompt, if present, will be prepared for evaluation. Or, the artificial intelligence model may conclude that the evaluation failed (e.g., because it reached the maximum number of allowed attempts or the model realizes that there is no appropriate action to fulfill the prompt). If the failed prompt is optional or the execution mode is non-strict, then the next prompt, if present, may be prepared for evaluation. Otherwise, the process stops.

The details of the action, to be performed on the device returned by an artificial intelligence model, are processed and sent to the device using appropriate application programming interfaces. The results of performing the action may be continuously added to validation logs, which could be either continuously or at the end of the process output into external (file) artifacts.

After an action is performed on the device, the state of the device and software application may be refreshed and a new screenshot may be captured. The refreshed software application state and screenshot may be evaluated to determine if the current prompt should be evaluated again, or if the next prompt in the sequence should be evaluated, or if the test scenario is complete. The evaluation may be accomplished by prompting the artificial intelligence model with the new state and the current prompt to ask if the action is completed. If the model deems the action successful, then the next prompt, if present, will be prepared for evaluation. Otherwise, the process repeats with the current action up to a configurable number of times.

The entire process may terminate once a specific action cannot be completed after the maximum number of allowed attempts (unless it is an optional action or the execution mode is non-strict), or an assertion fails, or if all of the actions are completed successfully.

A key advantage of a directed approach is that there is encoding and decoding, and the encoding process creates a series of outlined steps. If the software application changes significantly, the downstream crawler could adapt those steps or the encoding step could also be altered in self-healing. However, assuming that nothing changes, quality assurance teams typically expect consistency in the decoding so that the results are repeatable and give signals such that if the test is run 100 times, it would give the same result for those 100 runs. In other words, if the application and server code has not changed, and a smoke test or regression test is performed, then the result from validation shouldn't vary. Artificial intelligence models can change as the model training changes, and some types of artificial intelligence models, such as LLMs, are by default non-deterministic. However, predictability is still expected from the test run. Another advantage is that where repeatability is expected, the system is able to detect issues that are on the operating system level (or the original equipment manufacturer level) and the tests are able to be shared and run in parallel across multiple devices.

According to some examples, the testing process may be scaled to (i) perform software application compatibility testing across original equipment manufacturers (OEMs), (ii) perform phase testing based on resources, and (iii) provide analysis of test artifacts. Emulators may be cheaper to run than real physical devices. Therefore, for cost-saving purposes, some software application developers may use one or more emulators to execute a particular user journey in the decoding phase. Typically, emulators are used for early functional testing, but some teams prefer to go directly to physical tests to reduce time. For example, if tests are running in the pre-submit phase, the tests may need to be extremely efficient to reduce developer waiting time.

Based on the results of the emulator test, one or more journeys may be flagged to be run on one or more physical devices, for example due to a failure in the journey execution. However, there are instances where even if an issue is not found, running the journeys would still require a physical device, but due to cost savings, software application developers may want to start running on a single physical baseline device.

Multiple physical runs may be triggered based on other signals, such as certain important journeys, known tests that interact with the physical hardware, tests that are known to not work or are historically unstable on emulators, etc. If there is an issue with the baseline run, the software application developer may want to know if the issue with the baseline run is specific to an original equipment manufacturer. To determine whether the issue with the baseline run is specific to an original equipment manufacturer, the baseline run may be run across different OEMs. The OEMs may be randomly chosen based on availability, but there could be a predetermined selection of individual OEM models. If an issue is found on the device model, depending on the importance of the journey, the tests may again be run on multiple device models of that OEM or even across multiple application programming interfaces on the same hardware. To reduce time, the tests may be shared and run in parallel. However, if there are no issues, the results may go directly to test artifact consolidation and analysis.

In some scenarios, the artificial intelligence model may determine that multiple actions must be performed in order to satisfy a prompt. In these scenarios, the artificial intelligence model may perform those actions before progressing on to the next prompt. As a non-limiting example, when a prompt describes one or more actions (e.g. check the box next to “Subscribe” and click “Done”.), the artificial intelligence model parses the prompt into separate actions and executes them.

As another non-limiting example, when the artificial intelligence model encounters a known scenario and determines that a number of actions not specified in the prompt itself are required to be performed, the known scenario may be cataloged and available to the artificial intelligence model with instructions on how to handle the known scenario. To illustrate, if the encoded prompt was “Login into the test account”, the artificial intelligence model may determine this is a known “Login” scenario, execute steps to enter the test account username and password into the appropriate fields, and click the action to “Login”. The artificial intelligence model may also take into account known scenarios specific to genres. The known scenarios for a general software application may be different than a game software application; however, there may be some overlap. For example, both game software applications and free software applications may have advertisements, and an item in the catalog may be generally understanding how to either dismiss advertisements or how to click through the advertisements to test them. However, game software applications may have a certain style of first time user experience to teach gameplay, so games might have a different way to walk through a tutorial than a typical software application.

As another non-limiting example, the artificial intelligence model may encounter an unexpected event or scenario that is not cataloged and poses an obstacle to the progress of the test. The artificial model may rely on the context of the current test and software application under test, as well as training data of software applications tested under similar situations, in order to determine additional actions that must be performed to continue with the test. For example, a test with the objective to “Make a call to George” may encounter a permissions dialog to “Allow the application to make calls”. The artificial intelligence model in this instance may understand that permission must be granted in order to “Make a call to George”, even though the instruction to accept the permission is not explicitly stated. Users can control the artificial intelligence model's ability to adapt and generate unscripted actions by controlling a “creativity” setting.

One key benefit of the guided or directed approach, where the test is defined by a series of prompts that map to one or more actions or assertions for a given test, is that it allows for intervention at any point during the execution of the test. Intervention allows the user (or program requesting the test) to (i) have the prompts executed, (ii) pause execution of the test at an arbitrary point after completing an indicated prompt, and (iii) allow the user manual intervention at the paused step of the user journey. Manual intervention may be used to gather data manually, generate tracing to measure performance, investigate the current state of the application under test by performing debugging operations, and modify the software application code prior to execution of a subsequent prompt.

Manual intervention may be triggered by specifying a prompt breakpoint. In one scenario, the prompt breakpoint may be specified in the test artifact as a type of step in the test prior to starting execution of the test. The breakpoint is placed before or after another prompt specified in the test. During execution, the test pauses execution at the breakpoint and yields control of the device and application to the user or program controlling test execution.

In another scenario, the prompt breakpoint may be specified when viewing or running a test from a program that offers a GUI. When viewing the prompts in the test artifact, the user can add a breakpoint to a prompt for which they want the service to pause execution prior to executing the specified prompt. Control of the software application and the device is then yielded to the program, which can take instructions from the user to perform investigative or data gathering tasks with the application or device under test.

In another scenario, the prompt breakpoint may be triggered at runtime. The service may be configured to pause execution of the test and yield control of the software application and device under test to the user or program when encountering a specified log output or runtime request for intervention. For example, the service may be configured to pause execution when the application under test outputs a specified log.

In another scenario, the prompt breakpoint may be based on the service. Depending on the configuration of the service by the user, the service may pause test execution at an arbitrary point where it deems that it may be valuable to the user or program requesting the test execution to intervene. For example, configuration of the service may request intervention when the software application displays an error message Conditions of the intervention requiring configuration of the service may be specified by (i) the test artifact, (ii) the build configuration files of the software application project being tested, (iii) graphical settings or setting files of the program requesting the test, or (iv) parameters passed to the application programming interface of the service at invocation of the test.

Throughout the decoding process, the artificial intelligence model may validate both actions (e.g., user interactions) and assertions. For example, an assertion might be “check that the cat-shaped button appears after clicking on the dog-shaped button” and then an action might be “click the cat-shaped button when it appears”. The artificial intelligence model may have to both validate the assertion that the cat-shaped button appeared and that cat-shaped button was able to be clicked. Either of these would then be returned in the eventual test results after the execution of the journey.

Test execution produces a variety of test artifacts, such as device and software application logs, screenshots and video recording of the device screen throughout test execution, device performance data, accessibility analysis of the software application, software application state as a user interface hierarchy, and if available, before/after every action, detailed description and execution results of every action. Test artifacts can be additionally post-processed to infer information that is not directly captured in any single artifact (e.g., overlaying screenshots with the results of the accessibility analysis).

Both test artifacts and post-processing results can be accessed as files or visualized with graphical user interface tools, either directly in the integrated development environment or in a format that can be visualized using another program than where the tests were executed. The graphical user interface can help describe the execution of the test both textually and visually. In addition, the graphical user interface can indicate a pass or fail for each prompt, and metadata can be provided with detailed information about the prompt to describe the reason for the pass/fail. For example, a failure could be caused by the software application, the device, an infrastructure error from the server, a network failure, etc. A crash could occur but it could be a non-critical background crash that doesn't affect the user. The graphical user interface can be then used to filter things that are technically crashes but have lower user impact.

Depending on storage capacity, test artifacts can contain even more detailed metadata including device logs keyed to each prompt, software application logs keyed to each prompt, logs of commands, a screenshot of the device screen during a prompt, a video of the device screen keyed with each prompt, or any device data.

In other examples, a journey could involve multi-device interactions. For example, testing scenarios for certain applications might involve interactions between multiple devices for a single user, but also across users. For a single user use case, an example might be that a user is opening a mail application on their watch. They star or “favorite” the message. Then in the phone tied to their watch, they check the mail application. The journey validation is that the mail starred on the watch is synched to the phone and reflected in the phone application. In different scenarios, the multi-device application for a single user use case may utilize different communication technologies. In some instances, the devices would need to be connected, either in a real physical scenario where the phone and watch are actually connected to the same host server or at least in the same physical rack in a data center. In other scenarios, a virtualized container can be created where the physical devices that are on the same local area network can be connected.

In other examples, multi-device testing can refer to one or more users communicating. An example journey could be User A, User B, and User C are members of a chat group. User A sends a message to the group. User B views the message on both his watch, phone, and automobile. User B responds to the group on his automobile. User C then sees the messages from both User A and User B and responds as well. Within this journey there could be multiple types of validation. First, there could be validation that Users A, B, and C are seeing the messages in the correct order. In addition, the messages may be sent in an uncorrupted manner. For example, if there are emoticons used in the message, then those emoticons may be sent. If the different version of the chat application doesn't have the emoticon, it may use a replacement emoticon.

Issues that occur may occur in production and need to be triaged back through the software development lifecycle. As journeys are run, the system may continuously analyze the test artifacts, or additional artifacts, as well as run analysis on production analytics data, both with an artificial intelligence model. The artificial intelligence model can be prompted to detect application issues or can automatically detect these issues as part of the flow.

New artifacts may be generated to help the user understand issues that occur in production that need to be triaged back through the software development lifecycle, and new artifacts to help the user determine approaches to resolve the issues. Examples of artifacts generated to help the user investigate or resolve detected issues can be, but are not limited to, annotated screenshots of the device display, annotated videos of the device display, visual or audio-based explanations and guidance, or code suggestions for the application itself or modifications to the test.

Approaches to resolve issues that occur in production can range from, but are not limited to, pop ups in the integrated development environment with advice on where the issue might be, links to the stack-trace to indicate the files that the developer should look at, or even the code fixes itself

Some minor issues may not require a developer to intervene. The administrator for the project may be able to set pre-configurations allowing certain types of issues to automatically be fixed by the artificial intelligence model. Where no manual intervention is required, the system may automatically be able to commit the code changes and then go through the rest of the normal checking flow. Examples of configurations may include allowing incorrect localization fixes, misspellings of words, user interface issues in different configurations like landscape vs portrait where buttons appear off-screen, etc. Alternatively, where a code change may require manual intervention, the system can help the developer prioritize the issues to fix. For example, the artificial intelligence model can help determine application issues in the following categories: security, performance, user experience (UX), application programming interface compatibility, or application stability.

Based on the importance of the category and how widespread the issue is, the artificial intelligence model may prioritize the issue in the queue for the developer to review. There may be other factors the artificial intelligence model may consider, such as the revenue-impact that it has. For example, in a game, an issue with a level or late-stage area within a game may impact few users, but would be an area all the whales are, and thus may be prioritized for revenue purposes. A developer may want the artificial intelligence model to prioritize issues that can be capable of being reproduced aka “repro”. The artificial intelligence model may review the general information coming in from production, previous test logs, the stack-trace, logging, etc. In some instances, repro may require running across multiple device models because if an issue is specific to an OEM, running on an emulator or a different OEM may not actually reproduce the issue. In addition, if the issue actually ends up being OEM-specific, this would be important to note as part of the logs to send back to the model so that the fix can actually be tested on the correct device model. If an issue can be reproduced, this also helps inform the artificial intelligence model of the correct area to target to change the code. The code can then be accepted by the developer, who may then commit the change.

In addition to the code changes, the artificial intelligence model would then assess whether the issue was covered by an existing journey and whether a new journey would need to be created or an old journey could be adapted to cover. If a new journey or a journey would need to be adapted, this would be created or modified by the artificial intelligence model, potentially with manual intervention if needed, and then saved into the project. The artificial intelligence model may also determine that the issue is best for an instrumentation test or a scripted automated test, rather than a codeless prompt-enabled directed journey, or best left to manual tests. Otherwise, once the issue has been covered and a journey is appropriate, the artificial intelligence model would then reproduce the issue once again and then run through the test on the new build to confirm the issue was actually fixed. Once the new build is released to production, the artificial intelligence model may continue to release and monitor back to the existing tests run and collect analytics from real user usage.

FIG. 1 illustrates an example of a computing system 100 operable to test software applications using artificial intelligence. The computing system 100 includes a device 190 and a server 192. The device 190 can be any user device, such a laptop computer, a desktop computer, a portable computing device, a mobile device, etc. The device 190 may be communicatively coupled to the server 192, via a network (not shown), such that the device 190 and the server 192 can exchange information and data.

The device 190 includes a processor 102, a memory 104 coupled to the processor 102, and a user interface 106 coupled to the processor 102. The memory 104 can correspond to a non-transitory computer-readable medium that includes instructions 105 executable by the processor 102 to perform the operations described herein. Although the device 190 depicts three components (e.g., the processor 102, the memory 104, and the user interface 106), it should be understood that in other examples, the device 190 can include additional components. For example, in other examples, the device 190 can include a keypad, a mouse, a modem, additional processors, additional memories and/or storage devices, a display screen, etc.

The processor 102 can be configured to execute the instructions 105 in the memory 104 to operate an integrated development environment 110 and present the integrated development environment 110 to a user (e.g., a software application developer/tester) via the user interface 106. The integrated development environment 110 can correspond to a software application that enables the user to develop and test program code (e.g., software application code). In particular, the integrated development environment 110 can function as a single mechanism for the user to build program code, edit program code, test program code, and package program code.

In FIG. 1, the integrated development environment 110 includes (i) an encoding artificial intelligence model 120 configured to encode user journeys during software testing and (ii) a decoding artificial intelligence model 130 configured to decode user journeys during software testing. Although FIG. 1 depicts the device 190 as hosting the artificial intelligence models 120, 130, in some examples, one or more of the artificial intelligence models 120, 130 may be hosted by the server 192. In these examples, data from the device 190 may be communicated (e.g., transmitted) to the server 192, the server 192 may process the data using one or more of the artificial intelligence models 120, 130 to generate output data, and the output data may be communicated (e.g., transmitted) back to the device 190. In some examples, the one or more of the artificial intelligence models 120, 130 may be a large language model or another neural network.

As described herein, the encoding artificial intelligence model 120 and/or the decoding artificial intelligence model 130 may employ a machine learning inference process to make predictions and/or output results. For example, the encoding artificial intelligence model 120 and/or the decoding artificial intelligence model 130 may be trained using a training dataset and a deep learning framework. Based on a pre-trained machine learning algorithm stemming from the training dataset and the deep learning framework, the artificial intelligence models 120, 130 may make predictions and/or output results. In some examples, techniques such as retrieval-augmented generation (RAG) may be utilized to enhance the accuracy and reliability of the generative artificial intelligence models 120, 130. In some examples, techniques such as low-rank adaptation (LoRA) may be used to reduce the number of trainable parameters.

As depicted in FIG. 1, the integrated development environment 110 also includes an editor 117. In other examples, the integrated development environment 110 can include other components, such as a compiler, a code generator, an interpreter, a debugger, etc.

In FIG. 1, the user may load a software application 113 to the device 190 for testing. The software application 113 may correspond to any computer program that performs a specific task or a plurality of tasks. In response to loading the software application 113, the device 190 may store software application 113 in the memory 104. In some scenarios, the user may use the device 190 to perform a user journey 122 through the software application 113. As a non-limiting example, the user may use the user interface 106 to navigate through the software application 113. In other scenarios, the user journey 122 can be performed outside of the device 190 and video (or screen shots) of the user journey 122 can be provided to the device 190.

The user interface 106 may be used to provide input data 112 to artificial intelligence model 120 in the integrated development environment 110. The input data 112 may be indicative of the user journey 122 associated with the software application 113. In some examples, providing the input data 112 indicative of the user journey 122 may include providing a video stream of the software application 113 running on the device 190. In these examples, the user journey 122 may be performed during the video stream. In other examples, providing the input data 112 indicative of the user journey 122 may include providing prerecorded video of the user journey 122 on the software application 113. In other examples, providing the input data 112 indicative of the user journey 122 may include providing one or more screenshots of the user journey 122 on the software application 113.

The artificial intelligence model 120 may be configured to identify, based on the input data 112, one or more journey steps 124 of the user journey 122. For example, as depicted in FIG. 1, the artificial intelligence model 120 may identify the journey step 124A, the journey step 124B, and the journey step 124C. Although three journey steps 124 are identified by the artificial intelligence model 120, in other examples, additional (or fewer) journey steps 124 may be identified. As a non-limiting example, in some examples, the artificial intelligence model 120 may identify forty journey steps 124. As another non-limiting example, in some examples, the artificial intelligence model 120 may identify a single journey step 124. Each journey step 124 may correspond to a user interaction with the software application 113 or an assertion associated with the software application 113.

In some examples, the artificial intelligence model 120 may identify the journey steps 124 by observing visual changes on the device 190 during the user journey 122. In some examples, the artificial intelligence model 120 may identify the journey steps 124 by observing, during the user journey 122, interactions with the user interface 106 of the software application and interactions with the device 190. Thus, the journey steps 124 may be identified based at least on visual changes on the device 190, the interactions with the user interface 106, or the interactions with the device 190.

The artificial intelligence model 120 may be configured to generate a natural language prompt 126 for each journey step 124. For example, the artificial intelligence model 120 may encode the journey steps 124 to generate the natural language prompt 126 for each journey step 124. To illustrate, the artificial intelligence model 120 may encode the journey step 124A to generate a natural language prompt 126A, the artificial intelligence model 120 may encode the journey step 124B to generate a natural language prompt 126B, and the artificial intelligence model 120 may encode the journey step 124C to generate a natural language prompt 126C. Each natural language prompt 126 may have a predefined structure.

After the natural language prompts 126 are generated by the artificial intelligence models 120, the user journey 122 is stored in the memory 104 as the set of natural language prompts 126.

The user may use the editor 117 to edit the natural language prompts 126. For example, the integrated development environment 110 may be configured to present each natural language prompt 126 for user inspection. Using the user interface 106 and the integrated development environment, the user may edit the natural language prompts 126. The processor may update the set of natural language prompts 126 stored in the memory based on the user edits and may log the user edits as additional context.

In some examples, the artificial intelligence models 120 may be configured to detect changes to the software application 113 that render a particular natural language prompt 126 outdated. In these examples, the artificial intelligence models 120 may determine characteristics of the user journey 122 and modify the particular natural language prompt 126 to generate a modified natural language prompt 126 based on the characteristics of the user journey 122. In particular, the modified natural language prompt 126 may be adaptive to the changes of the software application 113. The set of natural language prompts 126 may be updated based on the modified natural language prompt 126.

After the natural language prompts 126 are generated and updated, if necessary, the computing system 100 may facilitate testing of the user journey 122. In particular, the natural language prompts 126 representatives of the user journey 122 may be tested on a plurality of devices 194 (e.g., remote devices having different operating systems, original equipment manufacturers, versions, etc.) to detect and identify potential errors.

To illustrate, the set of natural language prompts 126 stored at the memory 104 may be provided to the artificial intelligence model 130. The artificial intelligence model 130 may be configured to decode the set of natural language prompts 126 to generate a corresponding set of executable instructions 132 indicative of the journey steps 124. To illustrate, the artificial intelligence model 130 may decode the natural language prompt 126A to generate one or more executable instructions 132A indicative of the journey step 124A, the artificial intelligence model 130 may decode the natural language prompt 126B to generate one or more executable instructions 132B indicative of the journey step 124B, and the artificial intelligence model 130 may decode the natural language prompt 126C to generate one or more executable instructions 132C indicative of the journey step 124C.

To reduce the resources at the device 190, the processor 102 may send the executable instructions 132 to the remote devices 194 at the server 192. For example, the server 192 includes device 194A, a device 194B, and a device 194C. Although three devices 194 are depicted, in other examples, the server 192 may include additional (or fewer) devices 194. The devices 194 at the server 192 may be virtual devices, physical devices, or both. Each device 194 may be configured to run the software application 113.

The device 190 may provide the set of executable instructions 132, indicative of the user journey 122, to the devices 194. Each device 194 may perform the user journey 122 by executing the executable instructions 132. Based on the performance of the user journey 122, the devices 194 may send validation data 150 to the device 190, indicating whether errors occurred when performing the user journey 122. For example, the device 194A may execute the executable instructions 132 to perform the user journey 122 at the device 194A. After performing the executable instructions 132, the device 194A may send validation data 150A to the device 190 to indicate whether there were errors or problems or whether natural language prompts 126 were successful. Similarly, the device 194B may execute the executable instructions 132 to perform the user journey 122 at the device 194B. After performing the executable instructions 132, the device 194B may send validation data 150B to the device 190 to indicate whether there were errors or problems. The device 194C may execute the executable instructions 132 to perform the user journey 122 at the device 194C. After performing the executable instructions 132, the device 194C may send validation data 150C to the device 190 to indicate whether there were errors or problems.

In some scenarios, after execution of particular executable instructions 132A corresponding to a particular natural language prompt 126A, execution of the set of executable instructions 132 may be paused for manual intervention. As a non-limiting example, the device 194A may execute the executable instructions 132A and send corresponding validation data 150A to the device 190. The device 194A may pause execution of the remaining portion of the user journey 122 (e.g., the remaining executable instructions 132B, 132C) while the user inspects the validation data 150A to determine whether there are issues to be corrected. Execution of the set of executable instructions 132 may be resumed after pausing execution for manual intervention.

In some scenarios, the validation data 150 may include one or more artifacts usable to describe execution of the set of executable instructions 132. The one or more artifacts include device logs keyed to each natural language prompt 126, application logs keyed to each natural language prompt 126, a screenshot of at least one device 194, or a video of at least one device 194. In these scenarios, the artificial intelligence models 120, 130 may be configured to process the one or more artifacts. In some scenarios, the artificial intelligence models 120, 130 may be prompted to detect issues with the software application 113 based on the one or more artifacts. The issues may include one of security issues, performance issues, user experience issues, application programming interface issues, or application stability issues. The artificial intelligence models 120, 130 may be configured to generate additional artifacts to resolve the issues.

The computing system 100 of FIG. 1 may improve software application testing by leveraging generative artificial intelligence to enable software application developers to test user journeys 122 of the software application 113 across a wide range of devices 194 to efficiently identify potential issues. By providing an end-to-end solution within an integrated development environment, the techniques described with respect to FIG. 1 may streamline the testing process, reduce manual testing, and improve the overall quality of the software application 113.

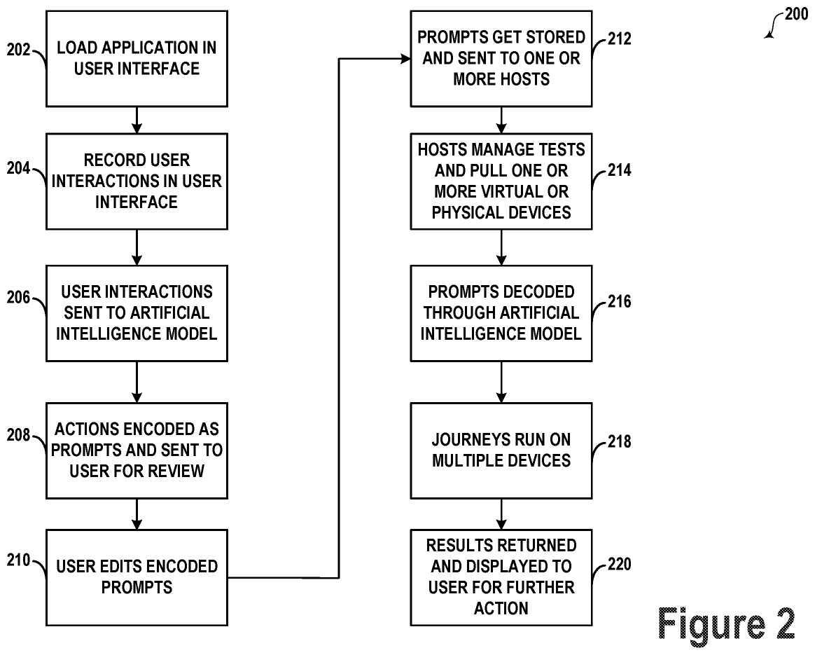

FIG. 2 illustrates an example of a computing process 200 for testing software applications using artificial intelligence. The computing process 200 can be performed by one or more of the components of the computing system 100 of FIG. 1. The computing process 200 illustrates the flow of an example of both encoding and decoding techniques.

According to the computing process 200, at block 202, the user (e.g., the software developer) can load an application in a user interface. For example, referring to FIG. 1, the user can load the software application 113 using the user interface 106. At block 204, user interactions in the user interface are recorded. For example, referring to FIG. 1, the user may use the user interface to execute the user journey 122 (e.g., a series of user interactions) during recording.

At block 206, the user interactions may be sent to an artificial intelligence model. For example, referring to FIG. 1, the user journey 122 (e.g., the series of user interactions) may be sent to the encoding artificial intelligence model 120. At block 208, the user interactions are encoded as prompts and sent to the user for review. For example, referring to FIG. 1, the encoding artificial intelligence model 120 encodes the user journey 122 (e.g., the series of journey steps 124) as the natural language prompts 126 and sends the natural language prompts 126 to the user for review. In some examples, the prompts 126 are text prompts. In another example example, the prompts 126 may be different screen clips with variations of interpretation. If the prompts 126 are screen clips, the prompts 126 may display the level of likelihood for each interpretation of the user interaction. At block 210, the user may edit the encoded prompts. The user can optionally choose an individual interpretation, or default to always have the encoding mechanism choose the highest ranked choice.

At block 212, the prompts may be stored and sent to one or more hosts. For example, referring to FIG. 1, the encoded natural language prompts 126 may be sent to a host machine (e.g., the device 190). At block 214, the hosts manage tests and pull one or more virtual or physical devices. For example, referring to FIG. 1, the device 190 may manage the tests associated with the natural language prompts 126 and may pull the devices 194 from the server 192. At block 216, the prompts are decoded through an artificial intelligence model. For example, referring to FIG. 1, the decoding artificial intelligence model 130 decodes the natural language prompts 126 to generate the executable instructions 132. Thus, the completed encoded test gets sent to a host machine which then runs the actions through a decoder.

At block 218, the journeys are run on multiple devices. For example, referring to FIG. 1, the devices 194 run the user journey 122 by executing the executable instructions 132. At block 220, the results are returned and displayed to the user for further action. For example, referring to FIG. 1, the validation data 150 is returned and displayed to the user. Thus, the actions are decoded by an artificial intelligence model and then distributed to be sent to one or more virtual or physical devices. After being run, the results are returned to a user for display and further action.

The computing process 200 improves software application testing by leveraging generative artificial intelligence to enable software application developers to test user journeys 122 of the software application 113 across a wide range of devices 194 to efficiently identify potential issues.

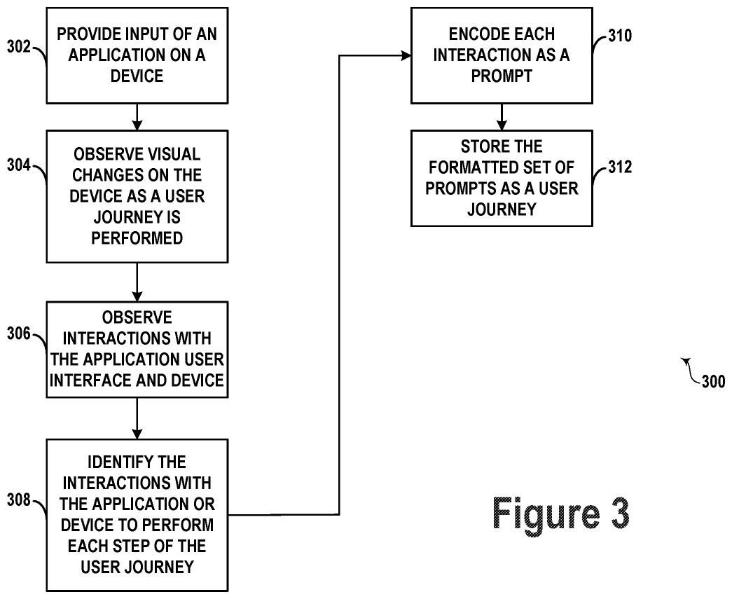

FIG. 3 illustrates an example of a computing process 300 for encoding a user journey as a set of prompts using artificial intelligence. The computing process 300 can be performed by the integrated development environment 110 and the encoding artificial intelligence model 120 of FIG. 1.

According to the computing process 300, at block 302, an input of an application on a device is provided to an integrated development environment 110. For example, referring to FIG. 1, an input of the software application 113 is provided to the integrated development environment 110. At block 304, visual changes on the device may be observed as a user journey is performed. For example, referring to FIG. 1, the integrated development environment 110 may observe visual changes on the device 190 as the user journey 122 is performed. At block 306, interactions with the application user interface and the device may be observed. For example, referring to FIG. 1, the integrated development environment may observe interactions with the user interface of the software application 113 and the device 190. Thus, according to the computing process 300, the integrated development environment observes visual changes on the device as a journey is performed as well as the interactions with the application user interface and the device during the journey.

At block 308, artificial intelligence may identify the interactions with the application or the device to perform each step of the user journey. For example, referring to FIG. 1, the encoding artificial intelligence model 120 may identify the interactions (e.g., the journey steps 124) of the user journey 122. At block 310, the artificial intelligence may encode each interaction as a prompt. For example, referring to FIG. 1, the encoding artificial intelligence model 120 may encode each journey step 124 as a natural language prompt 126. Thus, according to the computing process 300, the artificial intelligence model identifies the interactions with the application or the device to perform each step of the user journey and then encodes each interaction as a prompt written in natural language.

At block 312, the formatted set of prompts are stored as a user journey. For example, referring to FIG. 1, the set of natural language prompts 126 are stored in the memory 104 as the user journey 122.

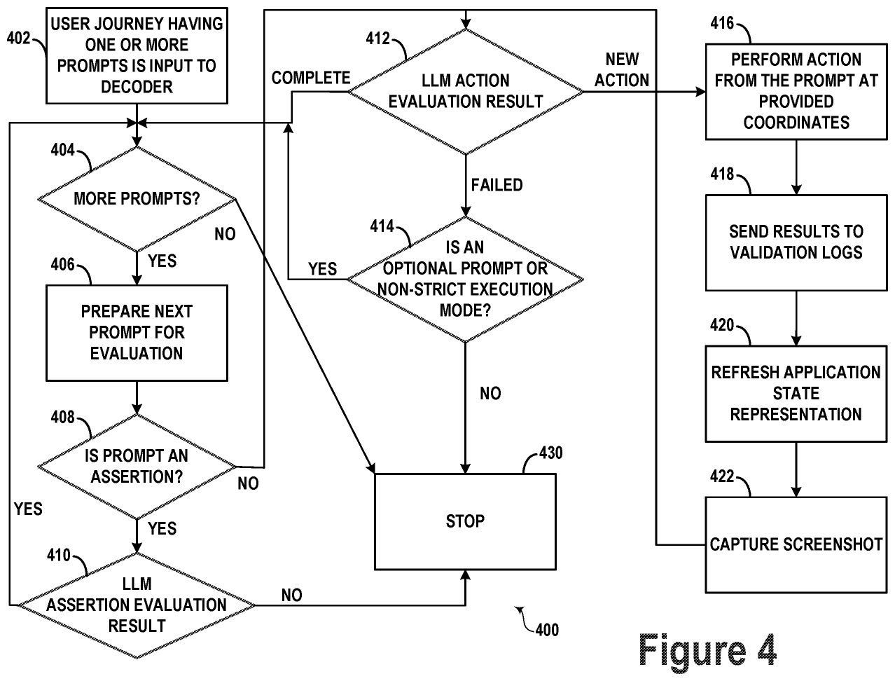

FIG. 4 illustrates another example of a computing process 400 for testing software applications using artificial intelligence. The computing process 400 can be performed by one or more of the components of the computing system 100 of FIG. 1. In particular, operations of the computing process 400 may be performed by the decoding artificial intelligence model 130 and the devices 194. The computing process 400 describes how user or machine-generated assertion and action descriptions are prepared as prompts for large language model evaluation and then performed as assertions and actions on the device.

At block 402, a user journey having one or more prompts is input to a decoder. For example, referring to FIG. 1, the natural language prompts 136 are provided to the decoding artificial intelligence model 130. At decision block 404, a determination is made whether there are more prompts to process. If there are no prompts to process, the computing process 400 ends at block 430. However, if there are prompts to process, the computing process 400 continues to block 406.

At block 406, a next prompt is prepared for evaluation. A large language model prompt is prepared using a prefix and suffix text depending on whether the prompt is an action (meant to return the details of an action to be performed on the device like screen coordinates, direction of a swipe, etc.) or an assertion (meant to evaluate a condition). At decision block 408, a determination is made whether the prompt is an assertion. If the prompt is an assertion, at decision block 408, the artificial intelligence mode evaluates the prompt with a response of only “yes” or “no”, at decision block 410, which determines the outcome of the assertion. If the assertion fails, at decision block 410, the computing process 400 ends, at block 430. However, if the assertion is successful, at decision block 410, the computing process 400 continues to decision block 404 to process the next prompt, if present.

At decision block 408, if the prompt is not an assertion, the computing process 400 proceeds to decision block 412. At decision block 412, the computing process 400 may conclude that the corresponding prompt has completed, determine that the evaluation failed, or return the details of an action to be performed on the device. If the computing process 400 concludes that the corresponding action completed, at decision block 412, the computing process 400 may return to decision block 404. If the computing process 400 determines that the evaluation failed (e.g., because it reached the maximum number of allowed attempts or the artificial intelligence model realizes that there is no appropriate action to fulfill the prompt), at decision block 412, the computing process 400 may continue to decision block 414. If the computing process 400 returns the details of the action to be performed on the device, at decision block 412, the computing process 400 continues to block 416.

At decision block 414, the computing process 400 may determine whether the failed prompt is an optional prompt or whether the execution mode is non-strict. If the prompt is optional (or the execution mode is non-strict), at decision block 414, the computing process 400 may return to decision block 404. However, if the prompt is not optional (or the execution mode is strict), the computing process 400 ends at block 430.

At block 416, an action from the prompt is performed at provided coordinates. In particular, the details of the action to be performed on the device returned by a large language model are processed into an action, which is sent to the device using appropriate application programming interfaces. At block 418, the computing process 400 sends results to validation logs. In particular, the results of performing the action are continuously added to validation logs, which could be either continuously or at the end of the process output into external (file) artifacts.

At block 420, the state of the device and the application are refreshed. At block 422, a new screenshot is captured. The refreshed application state and screenshot are then evaluated to determine if the current prompt should be evaluated again, or if the next prompt in the sequence should be evaluated, or if the test scenario is complete. In some examples, the determination may be accomplished by prompting the artificial intelligence model with the new state and the current prompt to ask if it is completed. If the model deems the action successful then the next large language model prompt, if present, will be prepared for large language model evaluation. Otherwise, the computing process 400 repeats with the current action up to a configurable number of times.

The computing process 400 terminates once a specific action cannot be completed after the maximum number of allowed attempts (unless it is an optional action or the execution mode is non-strict), or an assertion fails, or if all of the actions are completed successfully.

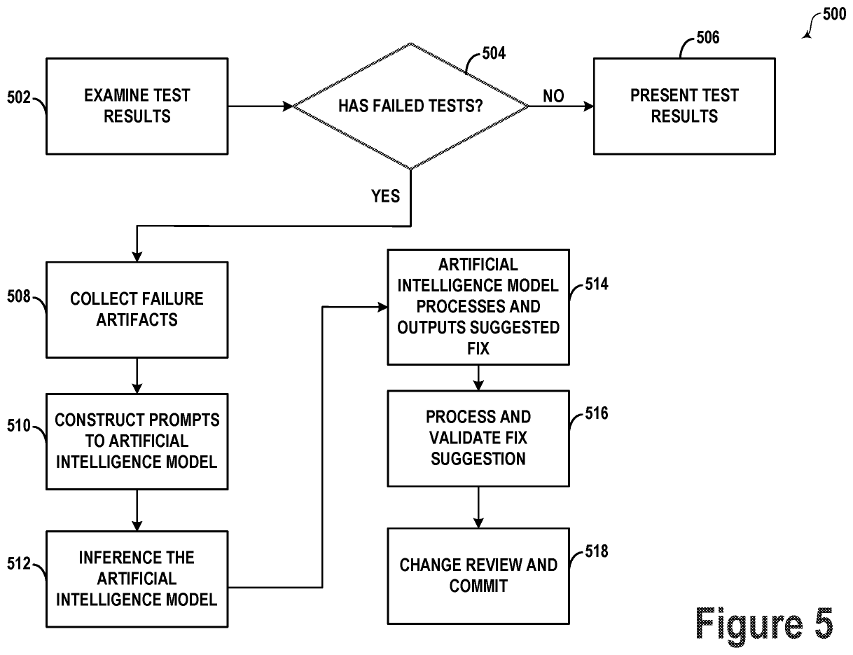

FIG. 5 illustrates another example of a computing process 500 for testing software applications using artificial intelligence. The computing process 500 can be performed by one or more of the components of the computing system 100 of FIG. 1. In particular, FIG. 5 depicts a self-healing process 500 which is triggered when a test failure is encountered consistently. That is, when the steps and desired outcomes of a test cannot be completed. An additional trigger for detecting the need to self-heal a test is test flakiness. A flaky test is one that generates inconsistent results, failing or passing unpredictably, without any changes to either the code under test or the test code itself.

According to the computing process 500, at block 502, test results are examined. For example, upon completion of a test, the automated testing system initiates a comprehensive evaluation process to determine the test's outcome. If the test is successful, at decision block 504, the test result will be presented in the user interface, at block 506 indicating that all test parameters were met and the desired results were achieved. This positive outcome signifies that the tested feature or functionality is operating as intended and meets the specified requirements.

Conversely, if the test fails, at decision block 504, the automated testing system takes immediate action to collect and securely store all relevant failure artifacts, at block 508. These artifacts may include error messages, stack traces, screenshots, the implementation source code, the test journey file, and any other pertinent information that can shed light on the root cause of the failure. By collecting and preserving these artifacts, the system ensures that they are readily available for further analysis by developers, traditional software systems, or artificial intelligence systems.

At block 510, to enhance the comprehension capabilities of the artificial intelligence system, collected failure artifacts may be leveraged to construct prompts in a format that aligns with the artificial intelligence system's requirements and specifications. The prompts are designed to guide the artificial intelligence system towards understanding the context and nature of the failures, as well as the specific actions or behaviors that led to them. To ensure the effectiveness of the prompts, the service employs iterative refinement techniques. It may involve soliciting feedback from human experts, conducting controlled experiments, or utilizing automated optimization algorithms. The goal is to fine-tune the prompts to maximize their relevance and clarity for the artificial intelligence system.

Once the prompts have been crafted and finalized, at block 512, the prompts are delivered to the artificial intelligence system through a designated interface or a reliable communication channel. The integration of these prompts into the artificial intelligence system's inference processes enables it to perform specific tasks or generate desired outputs based on the information provided in the prompts.

The artificial intelligence system analyzes the content of the prompts, which serve as inputs, to extract relevant information. This information is then processed and utilized by the artificial intelligence system to inform its reasoning and decision-making processes. Through this analysis, the artificial intelligence system is able to identify potential issues or areas for improvement. As a result of this inference process, the artificial intelligence system generates a failure explanation, which provides insights into the cause of any identified problems. Additionally, at block 514, the artificial intelligence system suggests fixes to address these issues.

Before being sent for change review by developers or other software systems, the fix suggestions may undergo a rigorous validation process, at block 516, to ensure their quality and feasibility. This validation process may encompass multiple criteria essential for successful code integration and execution.

When the service recommends a change to either the test or the application code, the changes can be reviewed and committed, at block 518.

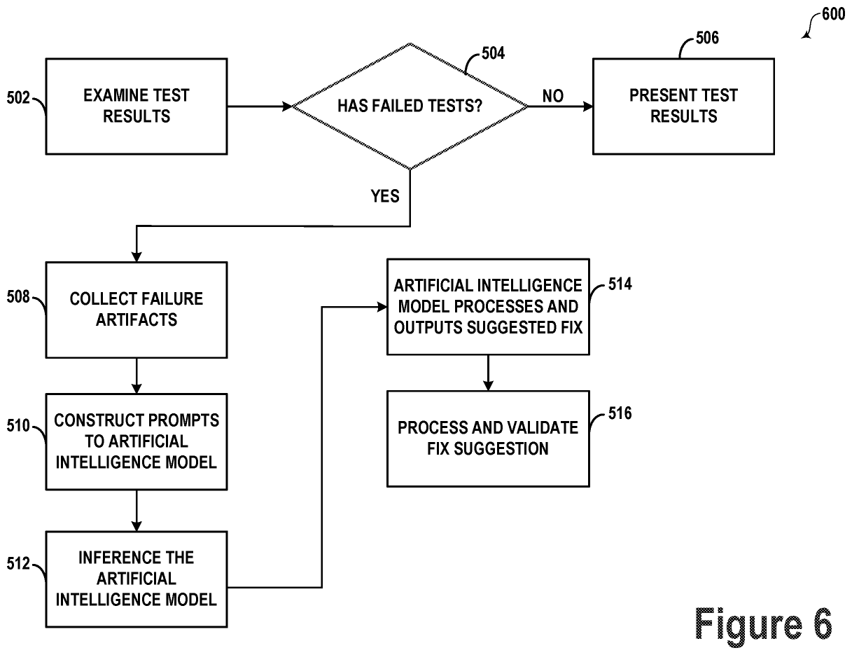

FIG. 6 illustrates another example of a computing process 600 for testing software applications using artificial intelligence. The computing process 600 can be performed by one or more of the components of the computing system 100 of FIG. 1. The computing process 600 of FIG. 6 is similar to the computing process 500 of FIG. 5; however, in FIG. 6, the recommended changes are automatically committed without requiring manual user review.

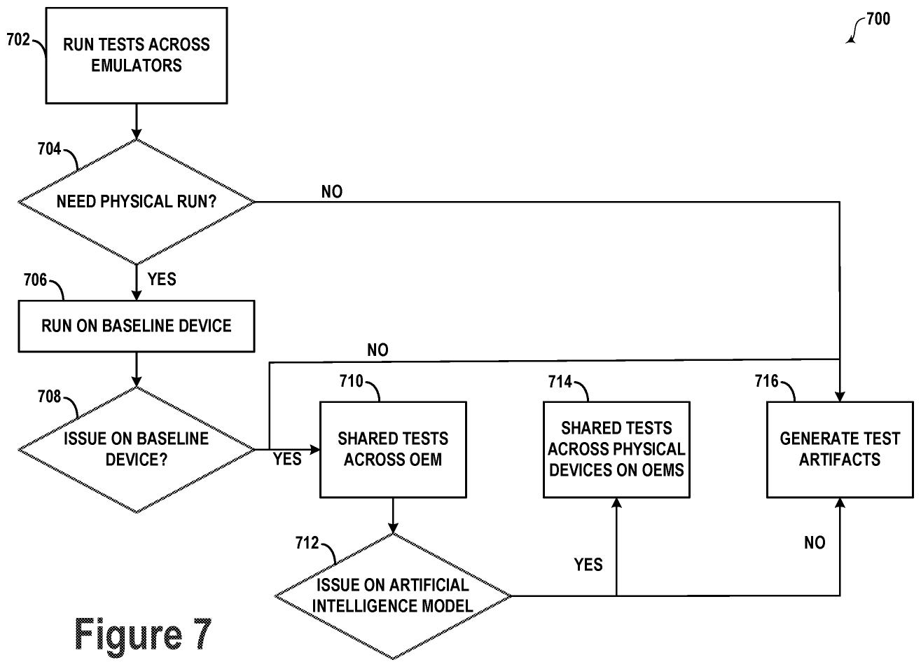

FIG. 7 illustrates another example of a computing process 700 for testing software applications using artificial intelligence. The computing process 700 can be performed by one or more of the components of the computing system 100 of FIG. 1. The computing process 700 provides an example flow of how to scale the testing process, for example, to perform application compatibility across original equipment manufacturers, phase testing based on resources, and provide analysis of test artifacts.

At block 702, tests may be run across emulators. Emulators are typically cheaper to run than real physical devices. Therefore, for cost-saving purposes, some developers prefer that the execution of a journey in decoding could occur on one or more emulators. Typically, emulators are used for early functional testing, but some teams prefer to go directly to physical tests to reduce time. For example, if tests are running in the pre-submit phase, the tests may need to be extremely efficient to reduce developer waiting time.

At decision block 704, the computing process 700 determines whether a physical run is necessary. For example, based on the results of the emulator test, one or more journeys may be flagged to be run on one or more physical devices (e.g., due to a failure in the journey execution). If a physical run is necessary, at decision block 704, the computing process 700 runs the test on a baseline device, at block 706. However, there are instances where even if an issue is not found, running the journeys would still require a physical device, but due to cost savings a developer may want to start running on a single physical baseline device, at block 706. If a physical run is not necessary, at decision block 704, the results may go directly to test artifact generation and analysis, at block 716.

At decision block 708, the computing process 700 may determine whether an issue occurred while running the test on the baseline device. If there is no issue, at decision block 708, the computing process may generate test artifacts, at block 716. However, if an issue is detected, at decision block 708, the computing process 700 proceeds to block 710. At block 710, the tests may be shared (e.g., run) across different OEMs. Thus, if there is an issue with the baseline run, at decision block 708, the developer may want to know if this is an OEM issue and may run the tests across all available models of OEM devices.

If an issue is found on the device model, at decision block 712, depending on the importance of the journey, the tests may again be run on multiple device models of that OEM, at block 714, or even across multiple application programming interfaces on the same hardware. To reduce time, the tests may be shared and run in parallel. However, if there are no issues, at decision block 717, the results may go directly to test artifact generation and analysis, at block 716.

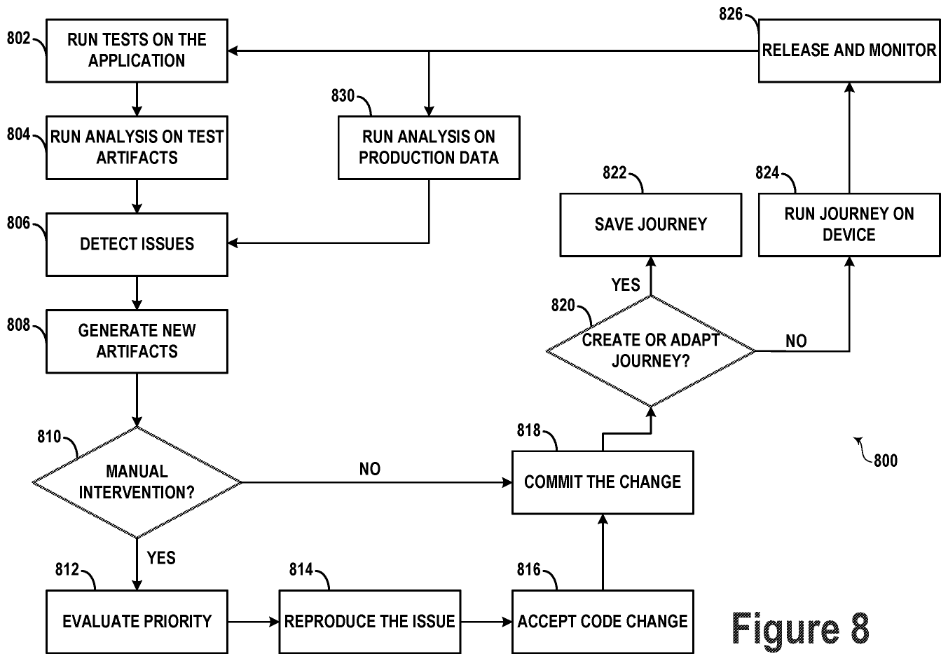

FIG. 8 illustrates another example of a computing process 800 for testing software applications using artificial intelligence. The computing process 800 can be performed by one or more of the components of the computing system 100 of FIG. 1. In particular, FIG. 8 depicts an example that helps to utilize existing test insights, production data, and other data to flow back through the end-to-end testing system.

At block 802, tests on an application are run. At block 804, analysis on test artifacts is run. At block 808, issues are detected. Thus, as user journeys 122 or manual tests are run, the system continuously analyzes the test artifacts (or additional artifacts) and runs analysis on production analytics data, at block 830.

At block 808, new artifacts are generated to help the user understand the issue, and new artifacts are generated to help the user determine approaches to resolve the issues.

Examples of artifacts generated to help the user investigate or resolve detected issue can be, but are not limited to, annotated screenshots of the device display, annotated videos of the device display, visual or audio-based explanations and guidance, or code suggestions for the application itself or modifications to the test.

At decision block 810, a determination is made whether manual intervention is necessary. Where no manual intervention is required, at decision block 810, the system may automatically be able to commit the code changes, at block 818, and then go through the rest of the normal checking flow. Examples of configurations could be things like allowing incorrect localization fixes, misspellings of words, user interface issues in different configurations, etc. Alternatively, where a code change may require manual intervention, at decision block 810, the system can help the developer prioritize the issues to fix, at block 812.

The artificial intelligence model may review the general information coming in from production, previous test logs, the stack-trace, logging, etc. to help reproduce the issue, at block 814. In some instances, reproduction may require running across multiple device models because if an issue is specific to an OEM, running on an emulator or a different OEM may not actually repro the issue. If an issue can be reproduced, at block 814, the artificial intelligence model may be informed of the correct area to target to change the code. The code can then be accepted by the developer, at block 816, who would then send then commit the change, at block 818.

In addition to the code changes, at decision block 820, the artificial intelligence model may assess whether the issue was covered by an existing journey and whether a new journey would need to be created or an old journey could be adapted to cover. If a new journey or a journey would need to be adapted, at decision block 820, this would be created or modified by the artificial intelligence model, potentially with manual intervention if needed, and then saved into the project, at block 822. The artificial intelligence model may also determine that the issue is best for an instrumentation test or a scripted automated test, rather than a codeless prompt-enabled directed journey, or best left to manual tests. Otherwise, once the issue has been covered and a journey is appropriate, at decision block 820, the artificial intelligence model may reproduce the issue once again run through the test on the new build to confirm the issue was actually fixed, at block 824. Once the new build is released to production, the artificial intelligence model may continue to release and monitor, at block 826, back to the existing tests and collecting analytics from real user usage.

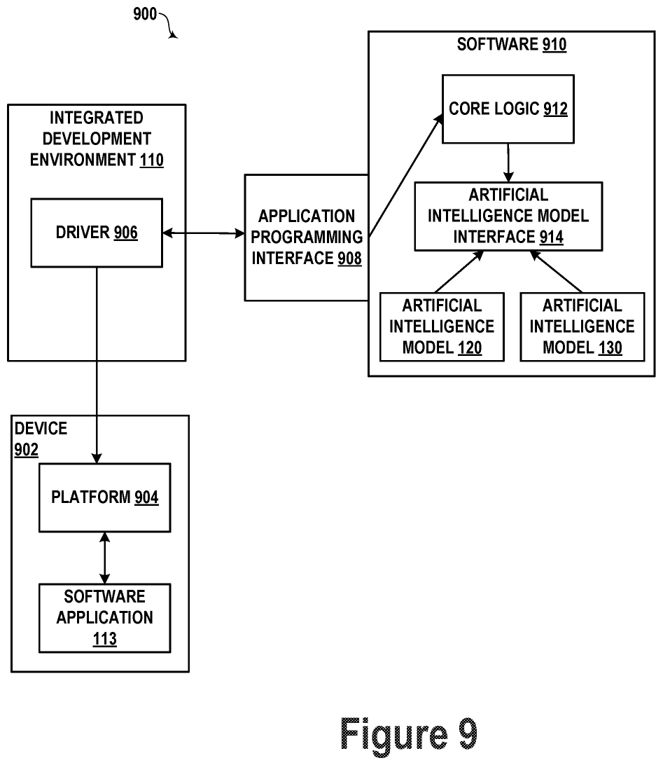

FIG. 9 illustrates an example of a computing system 900 operable to test software applications using artificial intelligence. The computing system 900 includes a device 902, the integrated development environment 110, an application programming interface 908, and software 910. In some examples, the computing system 900 may be integrated into the computing system 100 of FIG. 1. As a non-limiting example, the device 902 may correspond to the device 190 of FIG. 1, and the integrated development environment 110, the application programming interface 908, and the software 910 may be integrated into the device 902.

The device 902 includes a platform 904 that communicates with the software application 113. For example, the software application 113 may run on the platform 904. Thus, the user may utilize the platform 904 to perform the user journey 122 via the software application 113.

The integrated development environment 110 includes a driver 906 that is configured to control the platform 904. The application programming interface 908 is used to communicate signals between the driver 906 and the software 910. The software 910 includes core logic 912, an artificial intelligence model interface 914, and the artificial intelligence models 120, 130. The artificial intelligence models 120, 130 may communicate with the core logic 912 of the software 910 (e.g., the software that runs the test) via the artificial intelligence model interface 914.

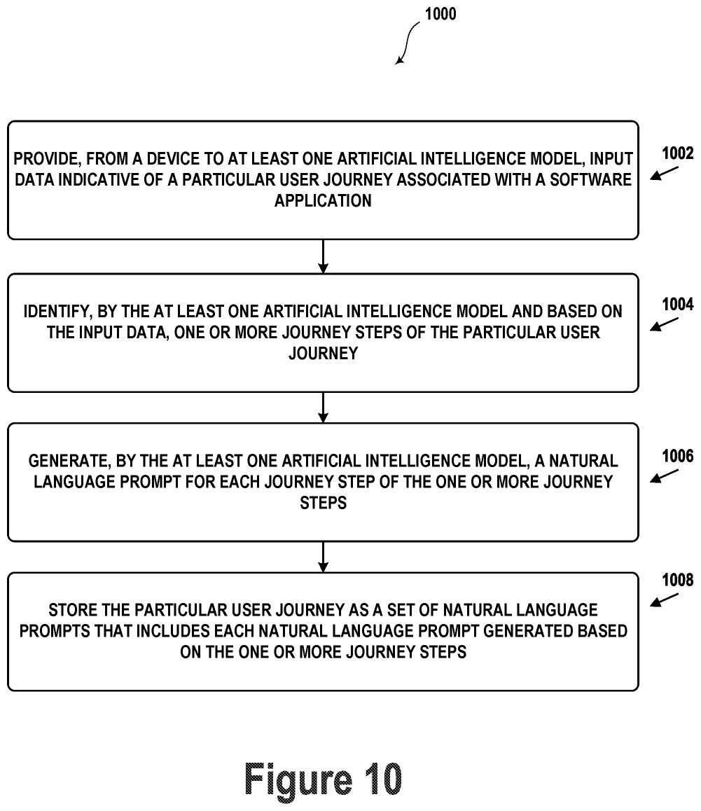

FIG. 10 illustrates a flow chart of a method 1000 related to a new technology. The method 1000 may be carried out by the computing system 100 among other possibilities. The examples of FIG. 10 may be simplified by the removal of any one or more of the features shown therein. Further, these examples may be combined with features, aspects, and/or implementations of any of the previous figures or otherwise described herein.

The method 1000 includes providing, from a device to at least one artificial intelligence model, input data indicative of a particular user journey associated with a software application, at block 1002. For example, referring to FIG. 1, the device 190 may provide, to the artificial intelligence model 120, the input data 112 indicative of the user journey 122 associated with the software application 113.

The method 1000 also includes identifying, by the at least one artificial intelligence model and based on the input data, one or more journey steps of the particular user journey, at block 1004. For example, referring to FIG. 1, the artificial intelligence model 120 may identify, based on the input data, the journey steps 124A-124C of the user journey 122.

The method 1000 also includes generating, by the at least one artificial intelligence model, a natural language prompt for each journey step of the one or more journey steps, at block 1006. For example, referring to FIG. 1, the artificial intelligence model 120 may generate the natural language prompt 126A-126C for each journey step 124A-126C.

The method 1000 also includes storing the particular user journey as a set of natural language prompts that includes each natural language prompt generated based on the one or more journey steps, at block 1008. For example, referring to FIG. 1, the device 190 may store the user journey 122 as the set of natural language prompts 126.

In some examples, the method 1000 may also include encoding the one or more journey steps to generate the natural language prompt for each journey step. In some examples of the method 1000, the one or more journey steps correspond to one or more user interactions with the software application, one or more assertions associated with the software application, or both.

In some examples of the method 1000, providing the input data indicative of the particular user journey includes providing a video stream of the software application running on the device. The particular user journey is performed during the video stream. In some examples of the method 1000, providing the input data indicative of the particular user journey includes providing prerecorded video of the particular user journey on the software application. In some examples of the method 1000, providing the input data indicative of the particular user journey includes providing one or more screenshots of the particular user journey on the software application. In some examples of the method 1000, providing the input data indicative of the particular user journey includes providing programmatic user interface hierarchy information of screens and actions associated with the particular user journey on the software application.

In some examples of the method 1000, identifying the one or more journey steps includes observing visual changes on the device during the particular user journey and observing, during the particular user journey, interactions with a user interface of the software application and interactions with the device. The one or more journey steps are identified based at least on one of the visual changes on the device, the interactions with the user interface, or the interactions with the device.

In some examples of the method 1000, each natural language prompt has a predefined structure. In some examples, the method 1000 includes presenting each natural language prompt for user inspection, updating the set of natural language prompts to include user edits, and logging the user edits as additional context.

In some examples, the method 1000 includes detecting changes to the software application that render at least one natural language prompt, in the set of natural language prompts, outdated. The method 1000 may also include determining characteristics of the particular user journey. The method 1000 may also include modifying the at least one natural language prompt to generate at least one modified natural language prompt based on the characteristics of the particular user journey. The at least one modified natural language prompt is adaptive to the changes to the software application. The method 1000 may also include updating the set of natural language prompts based on the at least one modified natural language prompt.

In some examples of the method 1000, the at least one artificial intelligence model comprises a large language model or a different neural network. In some examples of the method 1000, the at least one artificial intelligence model is hosted on the device. In some examples of the method 1000, the at least one artificial intelligence model is hosted on a remote server that is distinct from the device.

In some examples, the method 1000 includes providing, from the device to the at least one artificial intelligence model, the set of natural language prompts. The method 1000 may also include decoding, by the at least one artificial intelligence model, the set of natural language prompts to generate a corresponding set of executable instructions indicative of the one or more journey steps of the particular user journey. The method 1000 may also include providing the set of executable instructions to one or more second devices having the software application. The one or more second devices perform the particular user journey on the software application by executing the set of executable instructions. The method 1000 may also include receiving, from each device of the one or more second devices, validation data indicating whether errors occurred when performing the particular user journey.

The method 1000 of FIG. 10 may improve software application testing by leveraging generative artificial intelligence to enable software application developers to test user journeys 122 of the software application 113 across a wide range of devices 194 to efficiently identify potential issues. By providing an end-to-end solution within an integrated development environment, the method 1000 may streamline the testing process, reduce manual testing, and improve the overall quality of the software application 113.

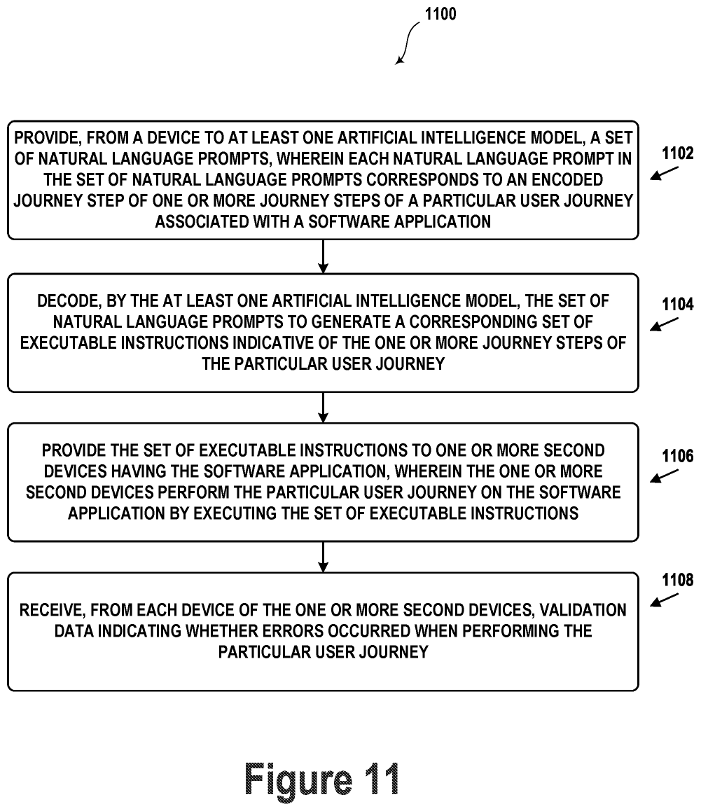

FIG. 11 illustrates a flow chart of a method 1100 related to a new technology. The method 1100 may be carried out by the computing system 100 among other possibilities. The examples of FIG. 11 may be simplified by the removal of any one or more of the features shown therein. Further, these examples may be combined with features, aspects, and/or implementations of any of the previous figures or otherwise described herein.

The method 1100 includes providing, from a device to at least one artificial intelligence model, a set of natural language prompts, at block 1102. Each natural language prompt in the set of natural language prompts corresponds to an encoded journey step of one or more journey steps of a particular user journey associated with a software application. For example, referring to FIG. 1, the device 190 may provide the set of natural language prompts 126 to the artificial intelligence model 130. Each natural language prompt 126A-126C in the set of natural language prompts 126 corresponds to an encoded journey step 124A-124C of the one or more journey steps 124 of the user journey 122 associated with the software application 113.

The method 1100 also includes decoding, by the at least one artificial intelligence model, the set of natural language prompts to generate a corresponding set of executable instructions indicative of the one or more journey steps of the particular user journey, at block 1104. For example, referring to FIG. 1, the artificial intelligence model 130 may decode the set of natural language prompts 126 to generate the corresponding set of executable instructions 132 indicative of the journey steps 124 of the user journey 122.

The method 1100 also includes providing the set of executable instructions to one or more second devices having the software application, at block 1106. The one or more second devices perform the particular user journey on the software application by executing the set of executable instructions. For example, referring to FIG. 1, the device 190 may provide the set of executable instructions 132 to the devices 194A-194C having the software application 113. The devices 194A-194C may perform the user journey 122 on the software application 113 by executing the executable instructions 132.

The method 1100 also includes receiving, from each device of the one or more second devices, validation data indicating whether errors occurred when performing the particular user journey, at block 1108. For example, referring to FIG. 1, the device 190 may receive validation data 150 indicating whether errors occurred when performing the user journey 122.

In some examples of the method 1100, each device of the one or more second devices performs the particular user journey on the software application in parallel. In some examples of the method 1100, at least one device of the one or more second devices comprises a virtual device. In some examples of the method 1100, at least one device of the one or more second devices comprises a physical device.

In some examples of the method 1100, after execution of executable instructions corresponding to a particular natural language prompt of the set of natural language prompts, execution of the set of executable instructions is paused for manual intervention. The method 1100 may also include resuming execution of a set of executable instructions after pausing execution of the set of executable instructions for manual intervention. In some examples of the method 1100, the validation data indicates whether each natural language prompt in the set of natural language prompts was successful.

In some examples of the method 1100, the validation data includes one or more artifacts usable to describe execution of the set of executable instructions. The one or more artifacts comprises device logs keyed to each natural language prompt, application logs keyed to each natural language prompt, a screenshot of at least one device of the one or more second devices, or a video of at least one device of the one or more second devices.

In some examples, the method 1100 may include processing, by the at least one artificial intelligence model, the one or more artifacts. The method 1100 may also include prompting the at least one artificial intelligence model to detect issues with the software application based on the one or more artifacts. The method 1100 may also include generating, by the at least one artificial intelligence model, additional artifacts to resolve the issues. The issues may include one of security issues, performance issues, user experience issues, application programming interface issues, or application stability issues.

The method 1100 of FIG. 11 may improve software application testing by leveraging generative artificial intelligence to enable software application developers to test user journeys 122 of the software application 113 across a wide range of devices 194 to efficiently identify potential issues. By providing an end-to-end solution within an integrated development environment, the method 1100 may streamline the testing process, reduce manual testing, and improve the overall quality of the software application 113.

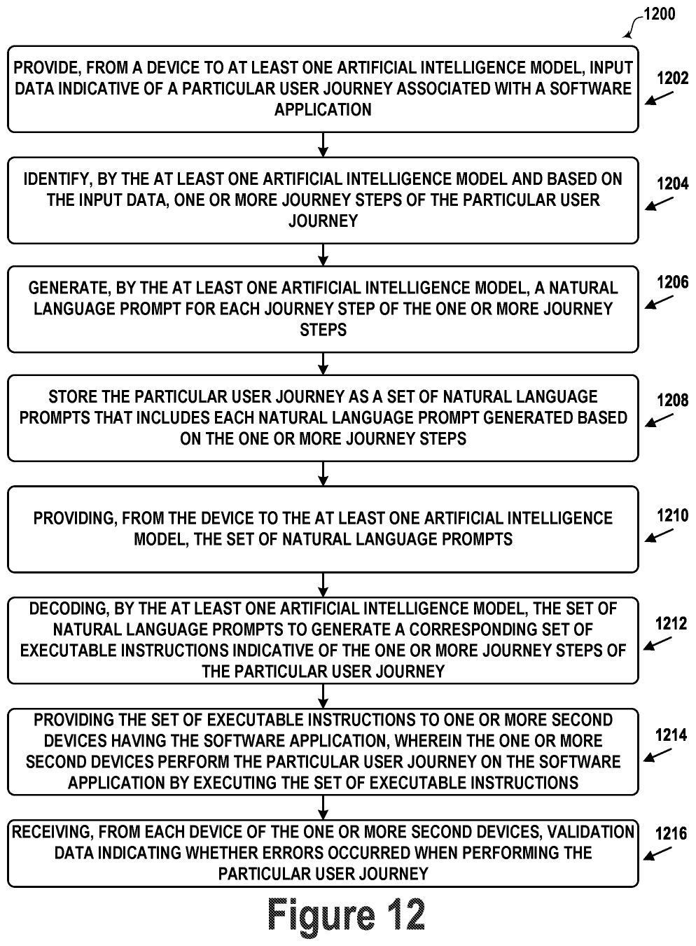

FIG. 12 illustrates a flow chart of a method 1200 related to a new technology. The method 1200 may be carried out by the computing system 100 among other possibilities. The examples of FIG. 12 may be simplified by the removal of any one or more of the features shown therein. Further, these examples may be combined with features, aspects, and/or implementations of any of the previous figures or otherwise described herein.

The method 1200 includes providing, from a device to at least one artificial intelligence model, input data indicative of a particular user journey associated with a software application, at block 1202. For example, referring to FIG. 1, the device 190 may provide, to the artificial intelligence model 120, the input data 112 indicative of the user journey 122 associated with the software application 113.

The method 1200 also includes identifying, by the at least one artificial intelligence model and based on the input data, one or more journey steps of the particular user journey, at block 1204. For example, referring to FIG. 1, the artificial intelligence model 120 may identify, based on the input data, the journey steps 124A-124C of the user journey 122.

The method 1200 also includes generating, by the at least one artificial intelligence model, a natural language prompt for each journey step of the one or more journey steps, at block 1206. For example, referring to FIG. 1, the artificial intelligence model 120 may generate the natural language prompt 126A-126C for each journey step 124A-126C.

The method 1200 also includes storing the particular user journey as a set of natural language prompts that includes each natural language prompt generated based on the one or more journey steps, at block 1208. For example, referring to FIG. 1, the device 190 may store the user journey 122 as the set of natural language prompts 126.

The method 1200 also includes providing, from the device to the at least one artificial intelligence model, the set of natural language prompts, at block 1210. For example, referring to FIG. 1, the device 190 may provide the set of natural language prompts 126 to the artificial intelligence model 130.

The method 1200 also includes decoding, by the at least one artificial intelligence model, the set of natural language prompts to generate a corresponding set of executable instructions indicative of the one or more journey steps of the particular user journey, at block 1212. For example, referring to FIG. 1, the artificial intelligence model 130 may decode the set of natural language prompts 126 to generate the corresponding set of executable instructions 132 indicative of the journey steps 124 of the user journey 122.

The method 1200 also includes providing the set of executable instructions to one or more second devices having the software application, at block 1214. The one or more second devices perform the particular user journey on the software application by executing the set of executable instructions. For example, referring to FIG. 1, the device 190 may provide the set of executable instructions 132 to the devices 194A-194C having the software application 113. The devices 194A-194C may perform the user journey 122 on the software application 113 by executing the executable instructions 132.

The method 1200 also includes receiving, from each device of the one or more second devices, validation data indicating whether errors occurred when performing the particular user journey, at block 1216. For example, referring to FIG. 1, the device 190 may receive validation data 150 indicating whether errors occurred when performing the user journey 122.

The method 1200 of FIG. 12 may improve software application testing by leveraging generative artificial intelligence to enable software application developers to test user journeys 122 of the software application 113 across a wide range of devices 194 to efficiently identify potential issues. By providing an end-to-end solution within an integrated development environment, the method 1200 may streamline the testing process, reduce manual testing, and improve the overall quality of the software application 113.

### EXAMPLES

### Example 1

A method of testing a software application includes providing, from a device to at least one artificial intelligence model, input data indicative of a particular user journey associated with the software application. The method also includes identifying, by the at least one artificial intelligence model and based on the input data, one or more journey steps of the particular user journey. The method further includes generating, by the at least one artificial intelligence model, a natural language prompt for each journey step of the one or more journey steps, and storing the particular user journey as a set of natural language prompts that includes each natural language prompt generated based on the one or more journey steps.

### Example 2

The method of Example 1 further includes encoding the one or more journey steps to generate the natural language prompt for each journey step.

### Example 3

In the method of Example 1 or 2, the one or more journey steps correspond to one or more user interactions with the software application, one or more assertions associated with the software application, or both.

### Example 4

In the method of any of Examples 1-3, providing the input data indicative of the particular user journey includes one of: providing a video stream of the software application running on the device, where the particular user journey is performed during the video stream; providing prerecorded video of the particular user journey on the software application; providing one or more screenshots of the particular user journey on the software application; or providing programmatic user interface hierarchy information of screens and actions associated with the particular user journey on the software application.

### Example 5

In the method of any of Examples 1-4, identifying the one or more journey steps includes observing visual changes on the device during the particular user journey, and observing, during the particular user journey, interactions with a user interface of the software application and interactions with the device. The one or more journey steps are identified based at least on one of the visual changes on the device, the interactions with the user interface, or the interactions with the device.

### Example 6

In the method of any of Examples 1-5, each natural language prompt has a pre-defined structure.

### Example 7

The method of any of Examples 1-6 further includes presenting each natural language prompt for user inspection, updating the set of natural language prompts to include user edits, and logging the user edits as additional context.

### Example 8

The method of any of Examples 1-7 further includes detecting changes to the software application that render at least one natural language prompt in the set of natural language prompts outdated. The method also includes determining characteristics of the particular user journey and modifying the at least one natural language prompt to generate at least one modified natural language prompt based on the characteristics of the particular user journey, where the at least one modified natural language prompt is adaptive to the changes to the software application. Finally, the method includes updating the set of natural language prompts based on the at least one modified natural language prompt.

### Example 9

In the method of any of Examples 1-8, the at least one artificial intelligence model includes a large language model.

### Example 10

The method of any of Examples 1-9 further includes providing the set of natural language prompts from the device to the at least one artificial intelligence model. The method also includes decoding, by the at least one artificial intelligence model, the set of natural language prompts to generate a corresponding set of executable instructions indicative of the one or more journey steps of the particular user journey. The method continues by providing the set of executable instructions to one or more second devices having the software application, where the one or more second devices perform the particular user journey on the software application by executing the set of executable instructions, and receiving, from each device of the one or more second devices, validation data indicating whether errors occurred when performing the particular user journey.

### Example 11

A system includes a memory and a processor coupled to the memory. The processor is configured to provide, from a device to at least one artificial intelligence model, input data indicative of a particular user journey associated with a software application; identify, by the at least one artificial intelligence model and based on the input data, one or more journey steps of the particular user journey; generate, by the at least one artificial intelligence model, a natural language prompt for each journey step of the one or more journey steps; and store the particular user journey as a set of natural language prompts that includes each natural language prompt generated based on the one or more journey steps.

### Example 12

In the system of Example 11, the processor is further configured to encode the one or more journey steps to generate the natural language prompt for each journey step.

### Example 13

In the system of Example 11 or 12, the one or more journey steps correspond to one or more user interactions with the software application, one or more assertions associated with the software application, or both.

### Example 14

In the system of any of Examples 11-13, to provide the input data indicative of the particular user journey, the processor is configured to provide a video stream of the software application running on the device, where the particular user journey is performed during the video stream; provide prerecorded video of the particular user journey on the software application; or provide one or more screenshots of the particular user journey on the software application.

### Example 15

In the system of any of Examples 11-14, to identify the one or more journey steps, the processor is configured to observe visual changes on the device during the particular user journey, and observe, during the particular user journey, interactions with a user interface of the software application and interactions with the device. The one or more journey steps are identified based at least on one of the visual changes on the device, the interactions with the user interface, or the interactions with the device.

### Example 16

In the system of any of Examples 11-15, each natural language prompt has a pre-defined structure.

### Example 17

In the system of any of Examples 11-16, the processor is further configured to present each natural language prompt for user inspection, update the set of natural language prompts to include user edits, and log the user edits as additional context.

### Example 18

In the system of any of Examples 11-17, the processor is further configured to detect changes to the software application that render at least one natural language prompt in the set of natural language prompts outdated. The processor is also configured to determine characteristics of the particular user journey, modify the at least one natural language prompt to generate at least one modified natural language prompt based on the characteristics of the particular user journey, where the at least one modified natural language prompt is adaptive to the changes to the software application, and update the set of natural language prompts based on the at least one modified natural language prompt.

### Example 19

In the system of any of Examples 11-18, the at least one artificial intelligence model includes a large language model.

### Example 20

In the system of any of Examples 11-19, the processor is further configured to provide the set of natural language prompts from the device to the at least one artificial intelligence model. The processor is also configured to decode, by the at least one artificial intelligence model, the set of natural language prompts to generate a corresponding set of executable instructions indicative of the one or more journey steps of the particular user journey. The processor is further configured to provide the set of executable instructions to one or more second devices having the software application, where the one or more second devices perform the particular user journey on the software application by executing the set of executable instructions, and receive, from each device of the one or more second devices, validation data indicating whether errors occurred when performing the particular user journey.

### Example 21

A non-transitory computer-readable medium includes instructions that, when executed by a processor, cause the processor to perform operations. The operations include providing, from a device to at least one artificial intelligence model, input data indicative of a particular user journey associated with a software application; identifying, by the at least one artificial intelligence model and based on the input data, one or more journey steps of the particular user journey; generating, by the at least one artificial intelligence model, a natural language prompt for each journey step of the one or more journey steps; and storing the particular user journey as a set of natural language prompts that includes each natural language prompt generated based on the one or more journey steps.

### Example 22

The non-transitory computer-readable medium of Example 21, wherein the operations further include providing the set of natural language prompts from the device to the at least one artificial intelligence model. The operations also include decoding, by the at least one artificial intelligence model, the set of natural language prompts to generate a corresponding set of executable instructions indicative of the one or more journey steps of the particular user journey. The operations further include providing the set of executable instructions to one or more second devices having the software application, where the one or more second devices perform the particular user journey on the software application by executing the set of executable instructions, and receiving, from each device of the one or more second devices, validation data indicating whether errors occurred when performing the particular user journey.

### Example 23

A method of testing a software application includes providing, from a device to at least one artificial intelligence model, a set of natural language prompts, where each natural language prompt in the set of natural language prompts corresponds to an encoded journey step of one or more journey steps of a particular user journey associated with the software application. The method also includes decoding, by the at least one artificial intelligence model, the set of natural language prompts to generate a corresponding set of executable instructions indicative of the one or more journey steps of the particular user journey. The method further includes providing the set of executable instructions to one or more second devices having the software application, where the one or more second devices perform the particular user journey on the software application by executing the set of executable instructions, and receiving, from each device of the one or more second devices, validation data indicating whether errors occurred when performing the particular user journey.

### Example 24

In the method of Example 23, each device of the one or more second devices performs the particular user journey on the software application in parallel.

### Example 25

In the method of Example 23 or 24, at least one device of the one or more second devices includes a virtual device.

### Example 26

In the method of any of Examples 23-25, after execution of executable instructions corresponding to a particular natural language prompt of the set of natural language prompts, execution of the set of executable instructions is paused for manual intervention.

### Example 27

The method of Example 26 further includes resuming execution of the set of executable instructions after pausing execution of the set of executable instructions for manual intervention.

### Example 28

In the method of any of Examples 23-27, the validation data indicates whether each natural language prompt in the set of natural language prompts was successful.

### Example 29

In the method of any of Examples 23-28, the validation data includes one or more artifacts usable to describe execution of the set of executable instructions, where the one or more artifacts include device logs keyed to each natural language prompt, application logs keyed to each natural language prompt, a screenshot of at least one device of the one or more second devices, or a video of at least one device of the one or more second devices.

### Example 30

The method of Example 29 further includes processing, by the at least one artificial intelligence model, the one or more artifacts; prompting the at least one artificial intelligence model to detect issues with the software application based on the one or more artifacts; and generating, by the at least one artificial intelligence model, additional artifacts to resolve the issues.

### Example 31

In the method of Example 30, the issues include one of security issues, performance issues, user experience issues, application programming interface issues, or application stability issues.

### Example 32

A system includes a memory and a processor coupled to the memory. The processor is configured to provide, from a device to at least one artificial intelligence model, a set of natural language prompts, where each natural language prompt in the set corresponds to an encoded journey step of one or more journey steps of a particular user journey associated with a software application. The processor is also configured to decode, by the at least one artificial intelligence model, the set of natural language prompts to generate a corresponding set of executable instructions indicative of the one or more journey steps of the particular user journey. The processor is further configured to provide the set of executable instructions to one or more second devices having the software application, where the one or more second devices perform the particular user journey on the software application by executing the set of executable instructions, and receive, from each device of the one or more second devices, validation data indicating whether errors occurred when performing the particular user journey.

### Example 33

A non-transitory computer-readable medium includes instructions that, when executed by a processor, cause the processor to perform operations. The operations include providing, from a device to at least one artificial intelligence model, a set of natural language prompts, where each natural language prompt corresponds to an encoded journey step of a particular user journey. The operations also include decoding the set of natural language prompts to generate a corresponding set of executable instructions, providing the executable instructions to one or more second devices to perform the user journey, and receiving validation data from the one or more second devices indicating whether errors occurred.

### Example 34

A method of testing a software application includes providing input data for a user journey from a device to an AI model, and having the AI model identify journey steps and generate a natural language prompt for each step. The method stores these prompts, then provides them to the AI model to be decoded into executable instructions. These instructions are provided to one or more second devices to perform the user journey, and validation data is received back indicating if any errors occurred.

### Example 35

A system for testing a software application includes a processor configured to provide input data for a user journey to an AI model, which identifies journey steps and generates a natural language prompt for each. The processor stores these prompts, then provides them to the AI model to be decoded into executable instructions. The instructions are then sent to one or more second devices to perform the user journey, and the processor receives validation data back indicating if any errors occurred.

### Example 36

A non-transitory computer-readable medium contains instructions that cause a processor to test a software application by providing input data for a user journey to an AI model. The instructions cause the processor to have the AI model identify journey steps, generate natural language prompts, store the prompts, and then provide the prompts back to the AI model for decoding into executable instructions. The instructions then direct the processor to provide these instructions to other devices to perform the journey and to receive validation data back.

### Example 37

A computer program product includes computer-executable program code that, when executed, causes a computer to test a software application. The code causes the computer to provide user journey input data to an AI model, which identifies steps and generates natural language prompts. The computer stores these prompts, provides them back to the AI model to be decoded into executable instructions, sends the instructions to other devices to perform the journey, and receives validation data indicating any errors.

### Example 38

A computer program product includes computer-executable program code that, when executed, causes a computer to provide input data from a device to an AI model indicative of a user journey. The code causes the computer to identify, via the AI model, one or more journey steps and generate a natural language prompt for each step. The code then causes the computer to store the user journey as a set of these natural language prompts.

### Example 39

A computer program product includes computer-executable program code that, when executed, causes a computer to provide a set of natural language prompts from a device to an AI model, where each prompt corresponds to a user journey step. The code causes the computer to decode these prompts via the AI model into executable instructions, provide the instructions to one or more second devices to perform the user journey, and receive validation data indicating if any errors occurred.

The present disclosure is not to be limited in terms of the particular examples described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The examples described herein and in the figures are not meant to be limiting. Other examples can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with examples. Alternative examples are included within the scope of these examples. In these alternative examples, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other examples can include more or less of each element shown in a given figure. Further, some of the illustrated elements can be combined or omitted. Yet further, an example can include elements that are not illustrated in the figures.

While various aspects and examples have been disclosed herein, other aspects and examples will be apparent to those skilled in the art. The various aspects and examples disclosed herein are for the purpose of illustration and are not intended to be limiting, with the true scope being indicated by the following claims.

What is claimed is:

1. A method of testing a software application, the method comprising:
providing, from a device to at least one artificial intelligence model, input data indicative of a particular user journey associated with the software application;
identifying, by the at least one artificial intelligence model and based on the input data, one or more journey steps of the particular user journey;
generating, by the at least one artificial intelligence model, a natural language prompt for each journey step of the one or more journey steps; and
storing the particular user journey as a set of natural language prompts that includes each natural language prompt generated based on the one or more journey steps.

2. The method of claim 1, further comprising encoding the one or more journey steps to generate the natural language prompt for each journey step.

3. The method of claim 1, wherein the one or more journey steps correspond to one or more user interactions with the software application, one or more assertions associated with the software application, or both.

4. The method of claim 1, wherein providing the input data indicative of the particular user journey comprises one of:
providing a video stream of the software application running on the device, wherein the particular user journey is performed during the video stream;
providing prerecorded video of the particular user journey on the software application;
providing one or more screenshots of the particular user journey on the software application; or
providing programmatic user interface hierarchy information of screens and actions associated with the particular user journey on the software application.

5. The method of claim 1, wherein identifying the one or more journey steps comprises:
observing visual changes on the device during the particular user journey; and
observing, during the particular user journey, interactions with a user interface of the software application and interactions with the device,
wherein the one or more journey steps are identified based at least on one of the visual changes on the device, the interactions with the user interface, or the interactions with the device.

6. The method of claim 1, further comprising:
presenting each natural language prompt for user inspection;
updating the set of natural language prompts to include user edits; and
logging the user edits as additional context.

7. The method of claim 1, further comprising:
detecting changes to the software application that render at least one natural language prompt, in the set of natural language prompts, outdated;
determining characteristics of the particular user journey;
modifying the at least one natural language prompt to generate at least one modified natural language prompt based on the characteristics of the particular user journey, wherein the at least one modified natural language prompt is adaptive to the changes to the software application; and
updating the set of natural language prompts based on the at least one modified natural language prompt.

8. The method of claim 1, further comprising:
providing, from the device to the at least one artificial intelligence model, the set of natural language prompts;
decoding, by the at least one artificial intelligence model, the set of natural language prompts to generate a corresponding set of executable instructions indicative of the one or more journey steps of the particular user journey;
providing the set of executable instructions to one or more second devices having the software application, wherein the one or more second devices perform the particular user journey on the software application by executing the set of executable instructions; and
receiving, from each device of the one or more second devices, validation data indicating whether errors occurred when performing the particular user journey.

9. A system comprising:
a memory; and
a processor coupled to the memory, the processor configured to:
provide, from a device to at least one artificial intelligence model, input data indicative of a particular user journey associated with a software application;
identify, by the at least one artificial intelligence model and based on the input data, one or more journey steps of the particular user journey;
generate, by the at least one artificial intelligence model, a natural language prompt for each journey step of the one or more journey steps; and
store the particular user journey as a set of natural language prompts that includes each natural language prompt generated based on the one or more journey steps.

10. The system of claim 9, wherein the processor is configured to encode the one or more journey steps to generate the natural language prompt for each journey step.

11. The system of claim 9, wherein the one or more journey steps correspond to one or more user interactions with the software application, one or more assertions associated with the software application, or both.

12. The system of claim 9, wherein, to provide the input data indicative of the particular user journey, the processor is configured to:
provide a video stream of the software application running on the device, wherein the particular user journey is performed during the video stream;
provide prerecorded video of the particular user journey on the software application; or
provide one or more screenshots of the particular user journey on the software application.

13. The system of claim 9, wherein, to identify the one or more journey steps, the processor is configured to:
observe visual changes on the device during the particular user journey; and
observe, during the particular user journey, interactions with a user interface of the software application and interactions with the device,
wherein the one or more journey steps are identified based at least on one of the visual changes on the device, the interactions with the user interface, or the interactions with the device.

14. The system of claim 9, wherein the processor is configured to:
detect changes to the software application that render at least one natural language prompt, in the set of natural language prompts, outdated;
determine characteristics of the particular user journey;
modify the at least one natural language prompt to generate at least one modified natural language prompt based on the characteristics of the particular user journey, wherein the at least one modified natural language prompt is adaptive to the changes to the software application; and
update the set of natural language prompts based on the at least one modified natural language prompt.

15. The system of claim 9, wherein the processor is configured to:
provide, from the device to the at least one artificial intelligence model, the set of natural language prompts;
decode, by the at least one artificial intelligence model, the set of natural language prompts to generate a corresponding set of executable instructions indicative of the one or more journey steps of the particular user journey;
provide the set of executable instructions to one or more second devices having the software application, wherein the one or more second devices perform the particular user journey on the software application by executing the set of executable instructions; and
receive, from each device of the one or more second devices, validation data indicating whether errors occurred when performing the particular user journey.

16. A method comprising:
providing, from a device to at least one artificial intelligence model, a set of natural language prompts, wherein each natural language prompt in the set of natural language prompts corresponds to an encoded journey step of one or more journey steps of a particular user journey associated with a software application;
decoding, by the at least one artificial intelligence model, the set of natural language prompts to generate a corresponding set of executable instructions indicative of the one or more journey steps of the particular user journey;
providing the set of executable instructions to one or more second devices having the software application, wherein the one or more second devices perform the particular user journey on the software application by executing the set of executable instructions; and
receiving, from each device of the one or more second devices, validation data indicating whether errors occurred when performing the particular user journey.

17. The method of claim 16, wherein, after execution of executable instructions corresponding to a particular natural language prompt of the set of natural language prompts, pausing execution of the set of executable instructions for manual intervention.

18. The method of claim 16, wherein the validation data includes one or more artifacts usable to describe execution of the set of executable instructions, wherein the one or more artifacts comprises device logs keyed to each natural language prompt, application logs keyed to each natural language prompt, a screenshot of a least one device of the one or more second devices, or a video of at least one device of the one or more second devices.

19. The method of claim 18, further comprising:
processing, by the at least one artificial intelligence model, the one or more artifacts;
prompting the at least one artificial intelligence model to detect issues with the software application based on the one or more artifacts; and
generating, by the at least one artificial intelligence model, additional artifacts to resolve the issues.
